(19) United States
(12) Patent Application Publication
(10) Pub. No.: US 2018/0359989 A1
(43) Pub. Date: Dec. 20, 2018

(54) Livestock Housing System

(71) Applicants: Lance T. Hampel, Fredericksburg, TX (US); L.T. Hampel Corp., Germantown, WI (US)

(72) Inventors: Lance T. Hampel, Fredericksburg, TX (US); Edward G. Wolk, Slinger, WI (US); Larry E. Brown, Appleton, WI (US)

(21) Appl. No.: 15/777,004

(22) PCT Filed: Nov. 16, 2016
(86) PCT No.: PCT/US2016/062270

§ 371 Date: May 17, 2018

Related U.S. Application Data
(60) Provisional application No. 62/256,307, filed on Nov. 17, 2015.
(60) Provisional application No. 62/271,556, filed on Dec. 28, 2015.
(60) Provisional application No. 62/382,044, filed on Aug. 31, 2016.
(60) Provisional application No. 62/403,461, filed on Oct. 3, 2016.

(51) Int. Cl. A01K 1/02; A01K 1/035; A01K 1/015; A01K 1/00; A01K 1/01

(52) U.S. Cl. CPC A01K 1/02; A01K 1/0356; A01K 1/01; A01K 1/0064; A01K 1/0151

(57) ABSTRACT

An animal housing unit has an enclosed monolithic hutch with an open front and a separate open top pen attached to the front of the hutch whereby an animal will be contained in the unit by the combination of the hutch and pen. The pen has a sliding roof that can be extended over the pen, with an extension that shields a feed bucket location from rain. The units can be supported on a composite steel and plastic base and drain through floor tiles can be used on the base, which can be supported on adjustable supports to support the base above or close to the ground. The roof is bi-laterally curved or partially spherical to promote shedding of rainwater, and gutters are molded into the hutch to channel rain away from the interior living space. Roof guiding and securement mechanisms are molded into the hutch and sliding roof. The sliding roof is double walled for insulation and strength and extruded members sandwich the lower edges of the hutch. The front of the pen bulges forwardly beyond the front bottom edge of the pen, the front has a door, a bottle holder in the front of the pen is wider at the distal end, and the front of the pen tapers in width forwardly and upwardly. The units can be provided with an elevated base, base skirts, a non-slip soft grate floor, a bucket and clip, a rain visor on the pen, back wall and rear corner ventilation, a manure catch pan, treatment flags, tie down hinges, a multiple roof movement system and a bedding tray.

### CROSS-REFERENCE TO RELATED APPLICATIONS

This claims the benefit of U.S. Provisional Patent Application No. 62/256,307 filed Nov. 17, 2015, U.S. Provisional Patent Application No. 62/271,556 filed Dec. 28, 2015, U.S. Provisional Patent Application No. 62/382,044 filed Aug. 31, 2016, and U.S. Provisional Patent Application No. 62/403,461 filed Oct. 3, 2016, the disclosures of which are hereby incorporated by reference for all purposes.

### STATEMENT CONCERNING FEDERALLY SPONSORED RESEARCH OR DEVELOPMENT

Not applicable.

### FIELD OF THE INVENTION

This invention relates to a livestock housing system and in particular to housing units for raising animals and particularly for raising calves.

### BACKGROUND OF THE INVENTION

Dairy calves are not near as hardy as their cousins that are raised for beef. Therefore, they are best sheltered from extreme weather elements, primarily from cold, damp and drafty conditions. There are numerous ways to shelter them, generally grouped into one of two areas: inside or outside. Raising calves inside, aside from the higher cost of the buildings, presents air circulation problems such that many calf raisers opt for outside methods.

Outside housing units come in many styles and shapes and are made of various different materials, among them, plastic, wood, fiberglass and metal. Plastic is the preferred material because hutches made of plastic possess superior ruggedness, can be thoroughly cleaned and sanitized, additional features are easier to mold into them, they are lightweight, shipping costs less because they nest, and they are commercially available worldwide.

Isolating the calves from one another in an outdoor environment is desirable because many common calf diseases are transmitted by body contact, contact with excrement or urine, or close proximity when air borne pathogens are present. For this reason individual calf housing units, commonly called hutches, are preferred. The sides have solid walls, and if there are wire pens in the front, the hutches are spaced apart enough to prevent contact. These hutches can be placed on the ground or raised off the ground. A common practice for raising healthy calves is a large hutch and pen combination placed directly on the ground and bedded with straw, sawdust or wood chips or the like. However, under certain conditions, calf raisers may choose to house calves in an elevated “housing system”. The main reasons and benefits for choosing this approach are: lack of sufficient space, improved calf health through cleanliness and ventilation, poor soil drainage, high cost of bedding, environmental rules requiring capturing run off, familiarity, and perception.

### BRIEF SUMMARY OF THE INVENTION

An animal housing unit of the invention has an enclosed monolithic hutch with an open front and a separate open-top pen attached to the front of the hutch whereby an animal will be contained in the unit by the combination of the hutch and pen. The hutch can be provided with a movable roof that can be extended over the pen, and can have an extension that shields a feed bucket position from rain.

The roof is preferably slideable and can be bi-laterally curved or partially spherical to promote shedding of rain water. Gutters and channels can be molded into the hutch to channel rain away from the interior living space.

Preferably, the pen tapers so that at the front portions of the pen in which vents are provided the pen is narrower than at the rear where the pen connects to the hutch, to keep adjacent animals out of contact with one another. The taper can be forwardly and/or upwardly.

Roof guiding and securement mechanisms can be molded into the hutch and sliding roof. The sliding roof is preferably double walled for insulation and strength. Extruded members that sandwich the lower edges of the hutch can be provided.

The front wall of the pen can be made so it extends outwardly beyond a lower edge of the front of the pen that is below where the front of the pen extends outwardly, to provide additional interior space for an animal while the pen is supported on a standard sized base.

Additionally, a bottle holder can be provided at the front of the pen that is wider at the distal end to facilitate insertion of bottles. A rain visor can be provided on the front of the pen that stays over the feed bucket whether the roof is extended or retracted. Buckets that can be attached to the front wall with a robust clip that is easy to install to the front wall and cooperates with the front wall structure to lock the bucket in place can also be provided.

Housing units of the invention can be supported on a composite steel and plastic base and multi-slotted drain-through “soft” floor tiles can be used on the base as the floor of each unit, that are easy to clean, promote ventilation in a manner that optimizes calf health and comfort and inhibit bacteria growth.

The base can be supported on adjustable supports to support the base above or close to the ground. The base enables four hutches to be moved at once and can be positioned over a wash alley. A skirt can be provided around the base, and it may be preferentially closed or opened to adjust air circulation depending on the weather and other factors and may be easily removable.

Clean out options can be provided for the unit including a roll out bedding tray, hinging the unit to the base so as to facilitate clean out and an easy empty catch pan under the base. Ventilation options can be provided including rear wall and corner adjustable vents in a manner that optimizes calf health and comfort, and a cover that acts as a rain visor and sun shade. Treatment flags and a multiple roof movement system may also be provided to facilitate taking care of the calves.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a single housing unit of the invention;

FIG. 2 is a left side view of the housing unit of FIG. 1;

FIG. 3 is a view like FIG. 1 with a sliding panel of the roof slid forward;

FIG. 4 is a view like FIG. 2 with the sliding panel of the roof slid forward like in FIG. 3;

FIG. 5 is a front elevational view of the housing unit of FIG. 1;

FIG. 6 is a rear elevational view of the housing unit of FIG. 1;

FIG. 7 is a top plan view of the housing unit of FIG. 1;

FIG. 8 is a bottom perspective view of the housing unit of FIG. 1;

FIG. 9 is a fragmentary perspective view showing details of the attachment of the sliding panel of the roof;

FIG. 10 is a fragmentary perspective view in cross-section showing additional details of the attachment of the sliding panel of the roof;

FIG. 11 is a fragmentary perspective view of the housing unit of FIG. 1 with the door open;

FIG. 12 is a perspective view showing the attachment of the front portion or pen of the housing unit to the rear portion or hutch of the housing unit;

FIG. 13 is a fragmentary perspective view from the rear of the housing unit showing how the sliding panel of the roof is laid on top of the rear portion of the housing unit (looking up at the bottom of the sliding panel) to assemble the sliding panel to the rear portion of the housing unit;

FIG. 14 is a fragmentary perspective view showing details of the sliding and securing structure for the sliding roof panel of the housing unit of FIG. 1;

FIG. 15 is a fragmentary perspective view showing details of the front of the housing unit with the sliding panel slid forward and secured and showing details of the bottle holder;

FIG. 16 is a rear perspective view of the housing unit of FIG. 1 with the rear window closed;

FIG. 17A is a fragmentary perspective view of the rear of the housing unit like FIG. 16 with the rear window open;

FIG. 17B is a fragmentary perspective cross-sectional view of the rear of the housing unit with the rear window open and showing details of a rain gutter around vent openings in the rear of the pen;

FIG. 18 is an exploded perspective view illustrating how extrusions on the sides and rear of the housing unit of FIG. 1 are attached to the rear portion (hutch) of the housing unit;

FIG. 19 is a cross-sectional view showing a profile of the bottom edge of the rear portion of the housing unit of FIG. 1 and of the bottom edge extrusion and how it is secured;

FIG. 20 is a perspective view of two housing units of a housing system of the invention shown side by side and elevated on a pedestal;

FIG. 21 is a fragmentary perspective view showing how corner hold-down devices engage the rear corners of the housing unit of FIGS. 1-20 to secure the housing unit or housing units to the base shown in FIG. 20;

FIG. 22 is a rear perspective view of the two housing units and base of FIG. 20;

FIG. 23 is an exploded perspective view showing how the housing units are attached to the base with the corner hold-downs;

FIG. 24 is a side elevational view of one of the housing units of FIG. 20 on the base showing the front portion (pen) of the housing unit and specifically showing the door in cross-section to show that it is double-walled and also showing the base in cross-section to show that it has slots through which excretions from the animal and other materials from above can drop;

FIG. 25 is a side elevational view showing how an embodiment of a housing unit of the invention can be provided with a rear portion similar to that of FIG. 1 but the front portion can be made of a metal wire pen made of pre-fabricated wire fence panels;

FIG. 26 is a fragmentary front view of the housing unit of FIG. 25 with the metal fence panel front;

FIG. 27 is a side elevational view with the front portion of the housing unit made of a twin-sheet plastic construction;

FIG. 28 is a side elevational view showing pivot arms that allow the front portion of the housing unit, whether it is plastic or metal, to be pivoted rearwardly up and over the rear portion of the housing unit so it allows the pen to tip up over the hutch, i.e., over the rear portion of the housing unit, so in the down position the pen would close the housing unit and in the up position the pen would open it, acting like a door into the housing unit;

FIG. 29A-D are views showing how a metal wire fence panel can be attached to the hutch using a bracket (eye of FIGS. 29A and 29B) and a clip (hook of FIGS. 29C and 29D);

FIG. 30 is a fragmentary elevational view showing details of a composite (hybrid) plastic and steel base that could be used to support one or more housing units of the invention as an alternative to a wood base or all plastic base;

FIG. 31 is a fragmentary elevational view showing additional details of the composite base of FIG. 30;

FIGS. 32A and 32B are elevational views showing additional details of the composite base and a bracket for attaching plastic portions of a composite base to the tubular metal frame;

FIG. 33 is a fragmentary elevational view of the composite base and showing where the section of FIG. 31 is taken from;

FIG. 34 is a perspective view of a metal pipe weldment frame which could be used in the composite base of FIGS. 30-33;

FIG. 35 is a fragmentary cross-sectional view showing an outer configuration that could be used at an edge of a plastic metal composite base, incorporating floor tiles as show in FIGS. 37, 41A and 41B;

FIG. 36 is a fragmentary cross-sectional view like FIG. 35 but showing a section through the center section of the composite base using the floor tiles;

FIG. 37 is a top elevational view showing how floor tiles of FIGS. 41A and 41B could be used to provide a grid floor supported by the composite base;

FIG. 38 is an alternative embodiment like FIG. 35 but showing the outer configuration of the alternative composite base utilizing an extruded foamed plastic construction;

FIG. 39 is a view through the center like FIG. 36 of the alternative extruded foam plastic composite base;

FIG. 40 is a view showing a mechanism by which the base can be supported either on the ground or elevated above the ground by turning a riser pipe to either one of two positions;

FIG. 41A is a top elevation view of a floor tile as described above and in previously described figures for a base to be used in a pen system of the invention;

FIG. 41B is a cross-sectional view from the plane of the line 41B-41B of FIG. 41A;

FIG. 42 is a front perspective view of an alternate elevated calf pen system of the invention showing four units elevated on a platform or base;

FIG. 43 is a view like FIG. 42 but with minimal reference numbers;

FIG. 44 is a view like FIG. 42 but from the opposite end;

FIG. 45 is a rear view of the system of FIG. 42;

FIG. 46 is a top perspective view of a base which would hold two of the units of FIG. 42, and with a support grid supported on the base;

FIG. 47 is a view like FIG. 46 of the base but with a plastic floor grate added above the support grid;

FIG. 48 is a view like FIG. 47 but with a skirt added on both long sides (i.e., on the front and rear sides;

FIG. 49 is a view of the floor grate alone;

FIG. 50 is a view like FIG. 47 but with two floor grates exploded above the base;

FIG. 51 is a detail perspective view of a version of the floor grate having projections extending upwardly from its top surface to inhibit a calf from slipping when standing on the grate;

FIG. 52 is a detail perspective view of a version of the floor grate having recesses extending downwardly from its top surface to inhibit a calf from slipping when standing on the grate;

FIG. 53 is a fragmentary perspective view showing an alternate prior art rubber coated steel grid floor grate supported on a welded steel tube (may be circular cross-section or rectangular cross-section tube) base;

FIG. 54 is a view like FIG. 53 but showing a housing unit supported on the floor supported on a non-elevated welded steel tube base and with the base enclosed within a wood or plastic wood frame;

FIG. 55 is a perspective view of an alternate accordion-folded skirt for the elevated base, FIG. 55 showing the skirt in the closed or unfolded position;

FIG. 56 is a view like FIG. 55, but with the skirt folded up in the open position;

FIG. 57 is a fragmentary perspective view showing a sample section of the skirt in the unfolded or closed position;

FIG. 58 is a fragmentary perspective view showing the sample section of the skirt of FIG. 57 folded up so that it would be open if installed on the base;

FIG. 59 is a perspective view of a new bucket;

FIG. 60 is a view like FIG. 59 with a mounting clip attached to the bucket;

FIG. 61 is a view of the bucket from the other end with a better view of the clip;

FIG. 62 is a cross-sectional view like FIG. 61;

FIG. 63 is a perspective top view of the bucket and clip;

FIG. 64 is a perspective bottom view of the bucket and clip;

FIG. 65 is a perspective view showing the bucket holder recess in the door which has a slot cut into its upper edge;

FIG. 66 is a detail perspective view of the slot cut into the upper edge of the wall of the bucket holder recess looking from the inward side of the door;

FIG. 67 is a detail front plan view of the slot cut into the upper edge of the wall of the bucket holder recess looking from the front side of the door, showing how the rear edge of the slot is elevated above the front edge;

FIG. 68 is a view of the front of the hutch with two buckets clipped in the bucket holding recesses in the front;

FIG. 69 is a perspective view of the clip for the bucket shown by itself;

FIG. 70 is a perspective view of a visor for the front of the pen over the feed bucket;

FIG. 71 is a perspective view of the visor assembled to the front of the pen over the feed bucket;

FIG. 71A is a cross-sectional view showing a bump-out structure in the front wall of the pen that helps lock the bucket in position;

FIG. 72 is a rear perspective view of one of the units showing rear wall vent openings which may optionally be provided;

FIG. 72A is a rear elevation view of the hutch showing the boundary of the area of the rear wall inside the dashed lines and of the corner area outside of the respective left and right dashed lines and wrapping around to each respective side of the respective corner;

FIG. 73 is a view like FIG. 72 but with doors closing the vent openings;

FIG. 74 is a view like FIG. 73 with the doors propped open by the hinge handle;

FIG. 75 is a view like FIG. 74 with only one door propped open and the lower door closed;

FIG. 76 is a view with the upper door closed and the lower door open;

FIG. 77 is a perspective view of a welded steel rod hinge handle for opening and closing the doors shown in FIGS. 73-76;

FIG. 78 is a detail view of a portion of FIG. 73 showing the hinge handle behind a support block holding the vent cover closed;

FIG. 79 is a detail view of a portion of FIG. 75 showing the hinge handle supported on the support block propping the vent cover open;

FIG. 80 is a detail view showing the hinge handle pulled out (extended) from behind the support block, with the vent cover closed;

FIG. 80A is a detail view showing how the hinge handle fits into holes in the rear of the vent cover with the hinge handle shown in the extended position;

FIG. 81 is a detail view showing the hinge handle pulled out from engagement with the support block, with the vent cover in the open position;

FIG. 82 is a detail view like FIG. 80 with the hinge handle pushed in (retracted) so as to engage behind the support block;

FIG. 82A is a detail view like FIG. 80A with the hinge handle in the retracted position;

FIG. 83 is a view like FIG. 81 with the hinge handle retracted and supported on the support block;

FIG. 83A is a perspective detail view showing an alternate support block for the hinge handle with the cover closed;

FIG. 83B is a perspective detail view showing the alternate support block for the hinge handle with the cover open;

FIG. 83C is a side elevation detail view of the support block in FIG. 83B;

FIG. 84 is a rear perspective view of one of the units with rear post ventilation covers in a closed position;

FIG. 84A is a cross-sectional view taken along line 84A-84A showing how the rear post ventilation covers slideably engage with the rear hutch corner structure;

FIG. 85 is a view like FIG. 84 but with the covers of the rear post ventilation raised so as to open the ventilation openings in the lower part of the hutch rear corners;

FIG. 86 is a front plan view of the base with two units on it and with a waste catch pan under each hutch under the base;

FIG. 87 is a perspective view of FIG. 86 with the waste catch pans pulled out in front of the base;

FIG. 88 is a perspective view of one of the catch pans;

FIG. 89 is a front perspective view of one of the units with a treatment flag held in a down position;

FIG. 90 is a view like FIG. 89 with the treatment flag in an up position;

FIG. 91 is a perspective view illustrating how units held on a base can be hinged to a rear edge of the base so as to be lifted at the front to facilitate cleaning out the unit;

FIG. 92 is a view like FIG. 91 but with the unit hinged at the front edge to facilitate cleaning out from the rear;

FIG. 93 is a perspective view illustrating a tie down hinge for hinging the unit to the base, with a central steel hinge knuckle welded on the base, end knuckles plastic molded as part of the hutch and a removable hinge pin extending through the three knuckles;

FIG. 94 is a perspective view illustrating two units on a base and with a multiple roof movement bar attached to the roofs of the two units;

FIG. 95 is a view like FIG. 94 but from the rear;

FIG. 96 is a top perspective view of a bedding tray for a hutch of the invention;

FIG. 97 is a perspective view of the base with the bedding tray placed on the base in the position of the left hutch and with the right hutch shown placed on the base with a bedding tray on the floor inside of it; and

FIG. 98 is a view like FIG. 97 but with the left hutch drawn in over the tray.

### DETAILED DESCRIPTION OF THE PREFERRED EMBODIMENT

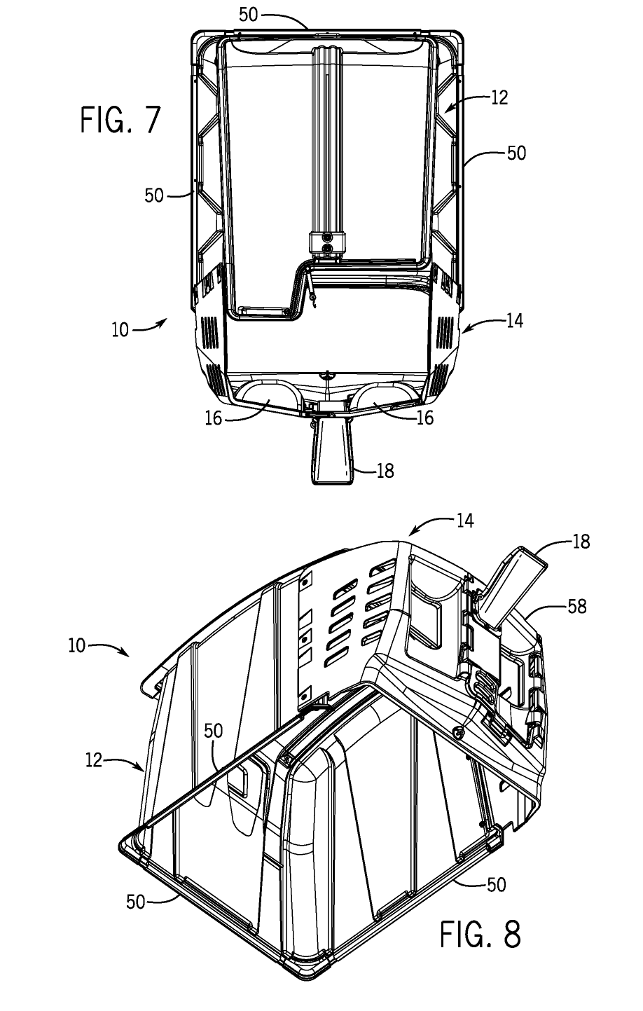

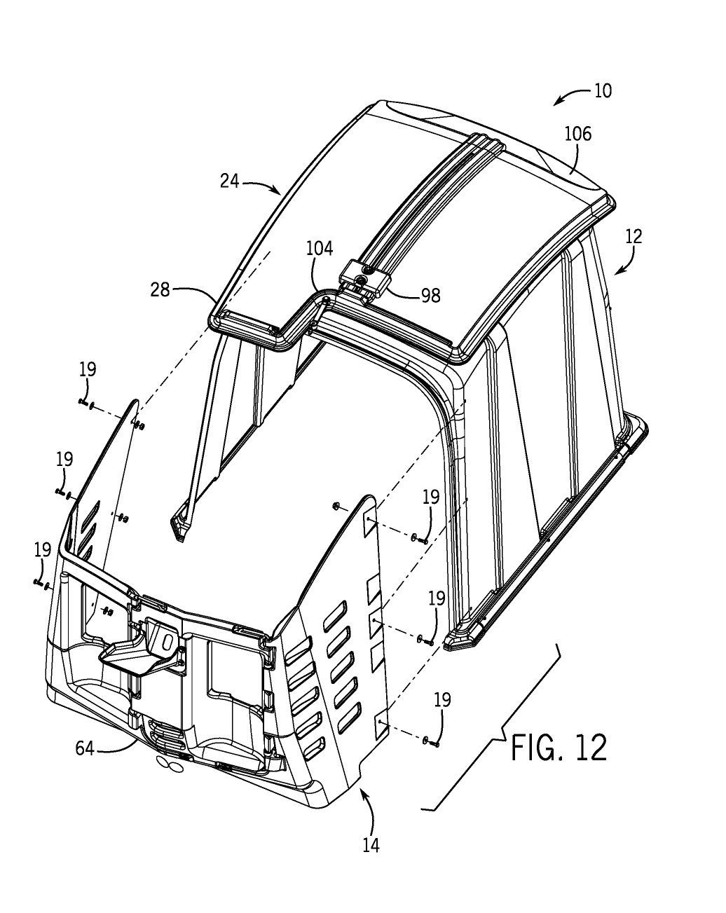

A general discussion of livestock confinement pens is provided in U.S. Pat. No. 8,186,306, the disclosure of which is hereby incorporated by reference for all purposes. The present housing unit 10 is specially adapted to be used in an elevated system, and may be elevated on wooden or other pedestals having spaced slats, a grid, drain tiles or any perforated surface that allows materials from above, such as excrement and urine, to fall through. Alternatively, it can be supported on the ground. As can be seen in FIGS. 1-7, each housing unit of the invention is self-contained and a self-supporting, sturdy unit, having a rear portion or hutch 12 having left and right sidewalls, a rear wall and a roof integrally connecting the side and rear walls in one monolithic unit. Each housing unit also has a separate front portion 14, sometimes referred to herein as a pen or pen front, that has left and right side walls and a front wall connecting the side walls and an open rear. The rear of the pen side walls are connected to the open front of the hutch 12 with fasteners 19 (FIG. 12). The pen 14 is open topped unless covered by a roof portion 24 supported by the hutch 12 that can be moved from being over the hutch 12 to being over the pen 14. It also has in the front wall of the front portion 14 pail holders 16, a bottle holder 18 and a latchable door 20 to keep an animal in or out and provide ingress and egress from the housing unit. The housing unit, including both portions 12 and 14, may be made of molded plastic material, which may be twin sheet thermoformed, and is easier to clean and keep clean than, for example, wood or metal, and therefore provides a more healthful environment for the calf. The hutches 12 taper from bottom to top and the pens taper from rear to front and bottom to top so as be stackable and nestable for shipping and storage purposes when the hutches and pens are disassembled from one another.

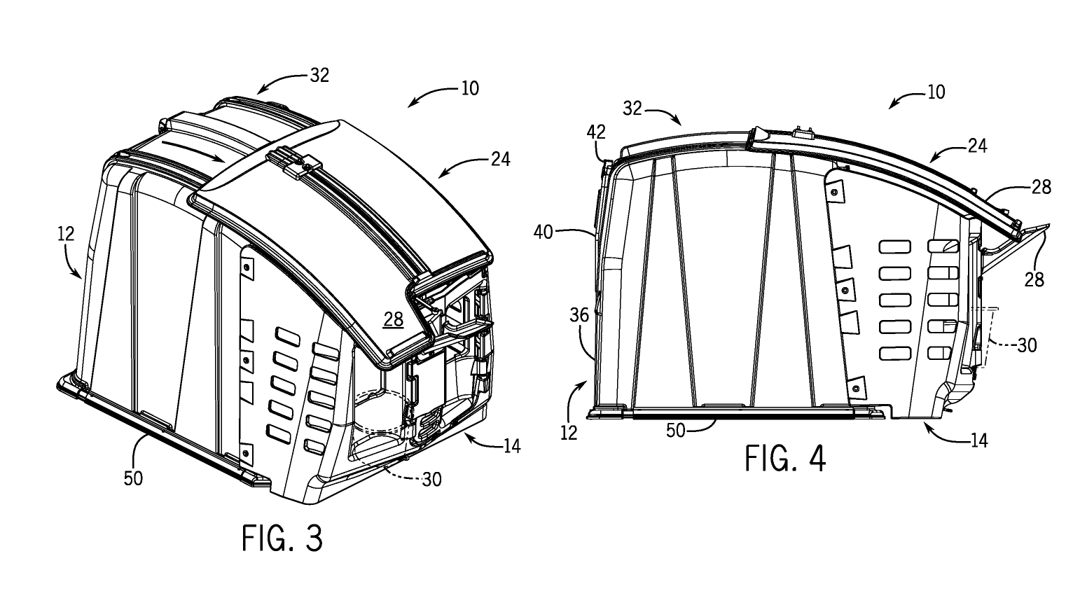

The housing units shown in the preceding figures all have an open bottom as shown in FIG. 8. The housing units shown also have a sliding roof portion 24 so that the front part of the top of the housing unit over the front portion 14 can be closed. An extension 28 of the sliding portion 24 is positioned and shaped so that it extends over the left pail holder when the sliding portion 24 of the roof is closed. This shields a feed bucket held in the left pail holder of the pen front from rain, as shown in FIGS. 3 and 4. The right pail holder can be used for a water bucket, which does not need to be shielded from the rain.

Housing units of the invention can be fixedly secured to wood, plastic, or metal platforms on which they are supported using fasteners, and therefore, via the platform, they are secured to one another in a fixed manner. They are made to be rigid when secured to the platform, but may also be so rigid so as to be individually self-supporting, not requiring to be secured to any support or to an adjacent housing unit so as to perform the function of containing and housing a calf.

As mentioned above, the hutch 12 is three-sided and has a roof to shelter and protect the animal from inclement weather and provide shade. The method of molding can be either thermoformed, blow molded, or rotational molded. Twin sheet thermoforming is presently preferred, but not the only possible method. Also, it is not necessary to twin-sheet mold this component, i.e., it may be molded with single wall thickness, for example using single sheet thermoforming.

The roof of the housing unit 10, including the stationary roof 32 of the hutch 12 and the sliding portion 24 of the housing unit 10, fully closes the top of the housing unit with the portion 24 fully extended, and is dome shaped or partially spherical shaped, being arcuate longitudinally (as viewed in side elevation, about a side to side lateral axis) and laterally (as viewed in front or rear elevation, about a longitudinal axis). This is for several reasons: The bi-lateral arcuate shape sheds rain in all directions rather than just two as would be the case if it was only unilaterally curved. In addition, the front to back curvature (about a lateral axis) allows using the moveable secondary roof portion 24, discussed further below, to be positioned with a downward slope both in the front and the back of the sliding portion whether it is extended or retracted, which is better for shedding rain.

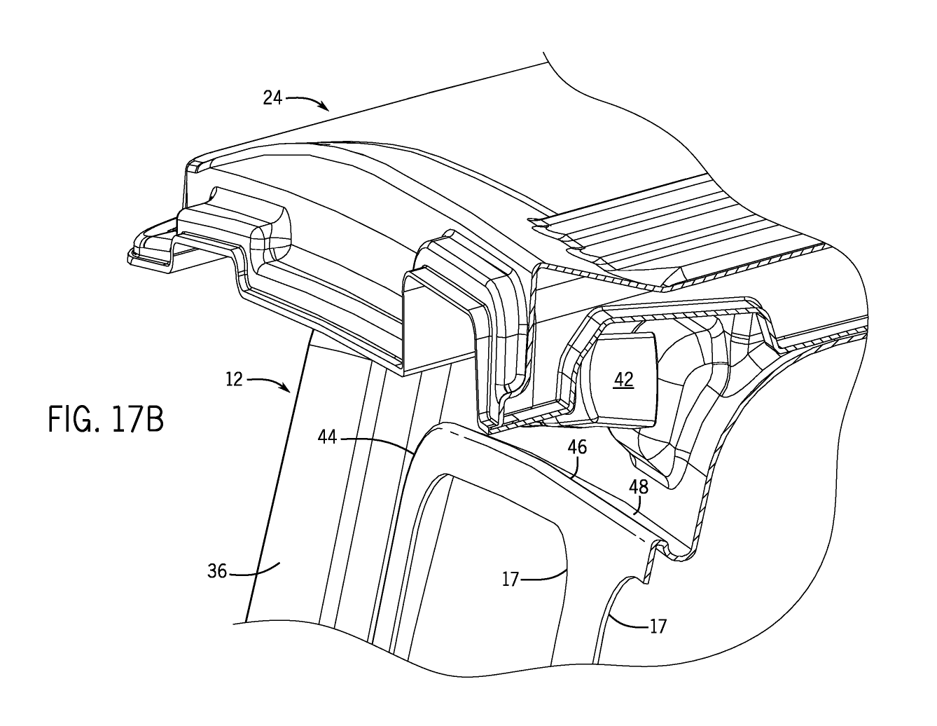

In addition, the rear wall 36 of the hutch 12 is in a vertical or near vertical plane for most of its height. This provides more space for the calf and reduces the potential for rain to enter the vents 38 (FIG. 17) through the rear wall 36.

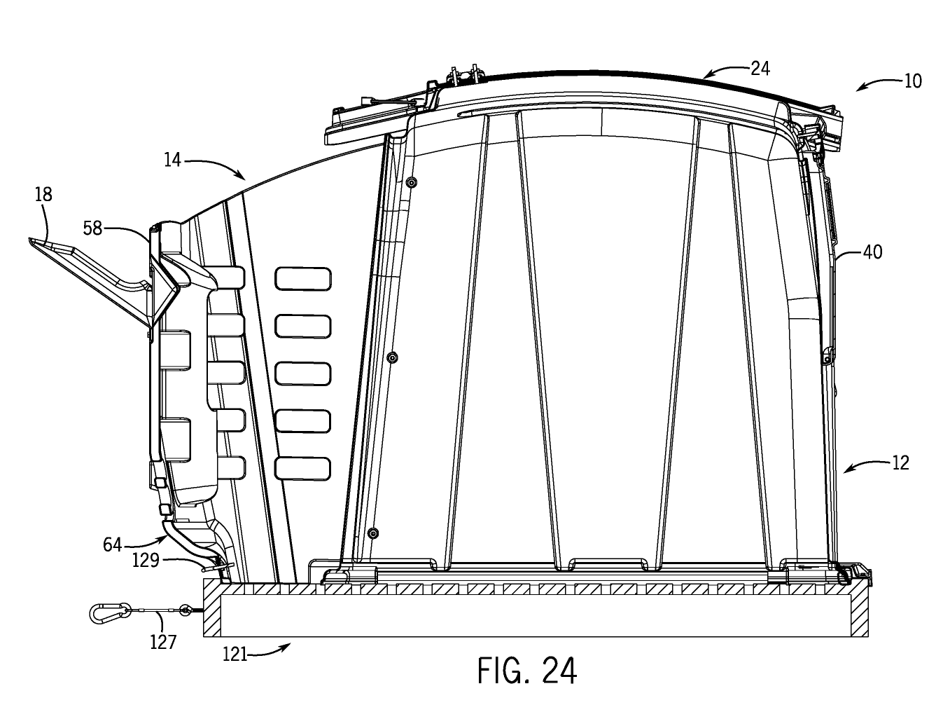

The vents 38 can be selectively covered by an operable vent door 40 that is molded plastic and therefore rainproof. The door 40 may be hinged along its bottom edge to the rear panel of the hutch 12, below the vents 38. A latch 42 above and between the vents 38 is fastened, with a screw or bolt providing its pivot axis, to the rear panel of the hutch 12 so the latch can be pivoted toward a horizontal position to unlatch the door 40 when the door is desired to be opened, for example to increase ventilation or light into the hutch 12. Alternatively, the latch 42 can be pivoted to a vertical position overlying the door 40 so as to latch it closed when the door is swung up over the vents 38, like when it is closed to shield out rain, air, or light. The door 40 may be single walled or double walled and in the embodiment as illustrated is single walled (FIG. 24).

Channels are molded into the hutch to accommodate the sliding mechanism described further below. The vent door 40 overlaps a raised portion 44 (FIG. 17A) that is molded into the back wall panel 36 of the hutch 12. The top flange 46 of that raised portion is eyebrow shaped (when viewed in rear elevation view) and has a rain gutter 48 molded into it to channel rain water off to the left and right sides where it is then channeled to the base of the hutch. The openings 17 cut into the hutch can be varied in shape and size to prevent the calf from escaping the hutch through them.

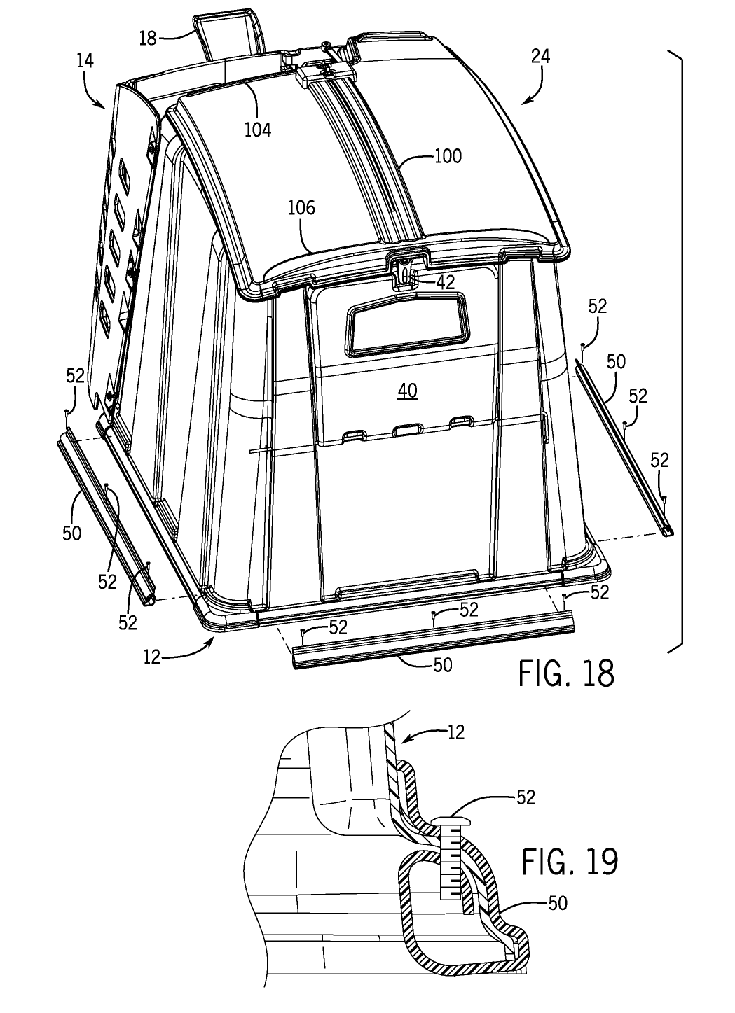

Referring particularly to FIGS. 18 and 19, the bottom edge of the three walls of the hutch 12 are reinforced with elongate profile members 50 of suitable length, which may be plastic extrusions that stiffen the edges so as to maintain the generally rectangular shape of the hutch 12. The hutch edge is sandwiched between two layers of each reinforcement member 50 and a third portion of the extrusion provides a plane of material generally perpendicular to the unwanted bending direction (horizontal) of the side walls and providing the required stiffness, and together with a generally vertical portion hides the termination of the fasteners 52 once they are installed. The horizontal portions of the member 50, including the bottom web and the corners, stiffen the walls against bending out of a generally vertical plane. The vertical portions of the members 50, including the inner wall, the outer wall, and the corners, stiffen the hutch walls against bowing enabling it to be more readily lifted from the bottom. Because the fasteners penetrate three layers, two layers of the member 50 plus one layer of the lower edge of the hutch, they have more holding power and maintain position more positively. Screws, rivets, or other suitable means may be used as the fasteners.

The pen front or front portion 14 of the housing unit 10 is a three-sided, double-walled structure that closes off the complete system to contain the calf. It is double walled to provide the structural strength given the fact it has no permanent roof like the hutch 12 that helps maintain its shape, especially given the fact that the front portion has so many openings and a door in it. The front portion 14 is not perfectly rectangular in shape but is narrower at the front than at the rear where it joins the hutch 12. This coupled with the size and position of the vents lessens the risk of calf-to-calf contact because where the vents are cut out, adjacent housing units are more distant from each other. If additional vents are necessary, a singular flat panel, likely plastic, can be inserted between the hutches to block contact but because of the taper of the front portion (both back-to-front and bottom-to-top taper), air will still circulate. The method of molding the front portion can be twin-sheet thermoformed, blow molded, or rotational molded—twin-sheet thermoforming being the presently preferred method.

Positions 56 are molded into the front and sides of the front portion 14 so that openings can be cut in for ventilation without exposing the hollow center of the front portion. More vents may be opened in hot climates and less where it is more temperate.

A hinged door 58 is provided in the front wall of the front portion 14 to allow placement of the calf into the system and also to allow access for caregivers to enter and exit as required. That door has integrally-molded hinge leaves like described in U.S. Pat. No. 8,186,306, pivoting on an L-rod 53 at one side that extends through interdigitated molded-in knuckles on the door and stationary portion of the front and with a similar latching mechanism with interdigitated molded-in knuckles on the door and front and a similar L-rod 57 on the other side that extends through the interdigitated knuckles. The door is molded in position on the front, and a secondary trimming operation separates it from the molded pen front. If for some reason a user did not want a functioning door, that trimming operation can be eliminated, with the door left as an integrally molded part of the front portion 14.

The front also contains the pail holders 16 and bottle holder 18. The pail holder for the water (right side) and the bottle holder are within the confines of the door. The remaining pail for the feed (left side) is in the stationary part of the front wall of the front portion 14.

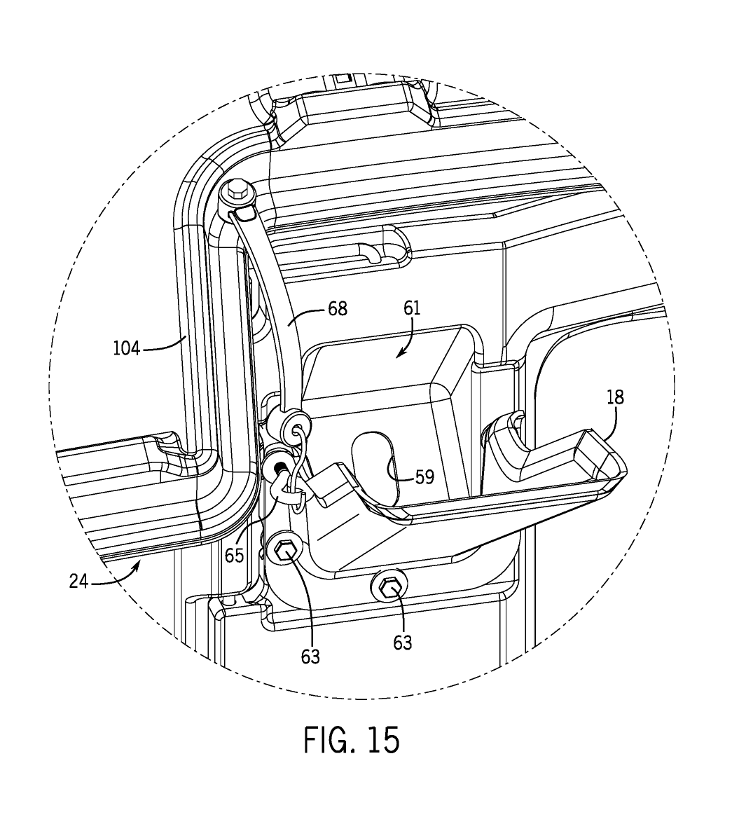

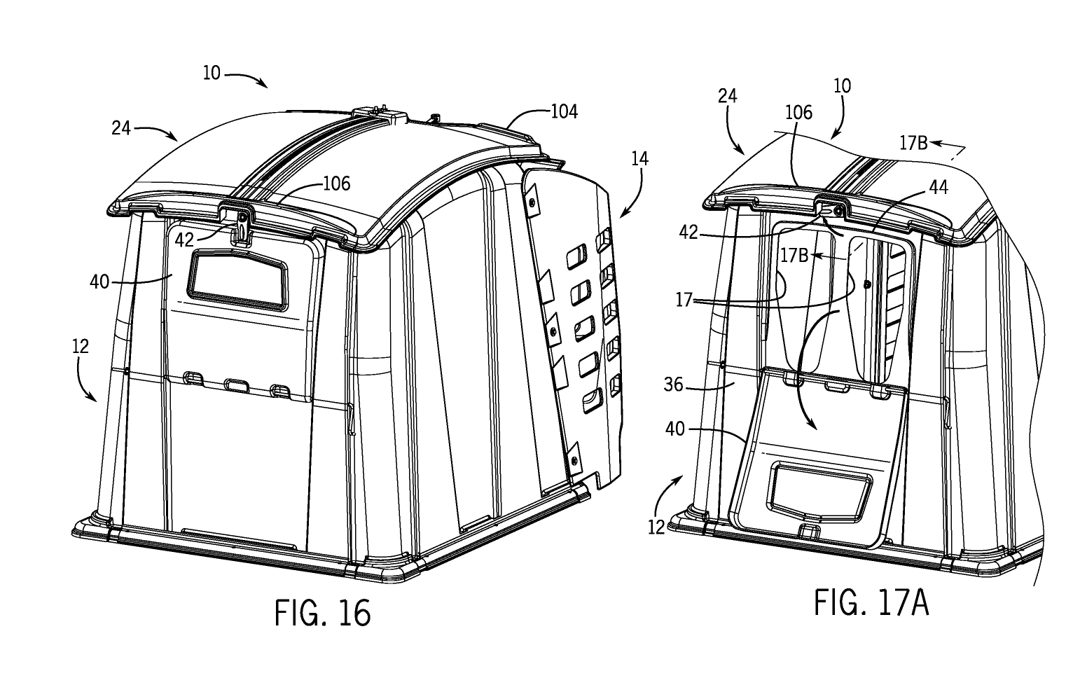

The bottle holder 18 (FIG. 15) is an open-top plastic “chute” that is molded separately from the front portion 14 and holds a bottle in place when the calf feeds. The bottle is placed in the holder with the nipple down and the nipple extends through an elongated hole 59 that is cut into a recess 61 molded into the door 58 that is shaped to interfit with the bottle holder. The bottle holder is attached to the door with fasteners 63 that extend through flanges of the bottle holder. One of the fasteners is an eye 65, to which an elastic strap 68 attached to the front of the slideable roof 24 may be hooked to secure the slideable roof portion 24 in the extended or open position. The shape of the bottle holder 18 facilitates quick insertion of the bottle. Some calf raisers have tens of thousands of calves on bottles and several seconds saved on each calf adds up. Therefore the entry end of the chute of the bottle holder 18 is wider than the area where it guides the nipple through the pen front. In other words, the bottle holder tapers in width from its distal end, which is its upward end, to its inward end, which is its lower end. The bottle holder 18 is angled upward to allow the bottle to slide in place and stay in place and the top of the bottle holder adjacent its entry end is open.

Additionally the sliding top when closed provides a totally closed system except for a few required permanent vents. The front double-walled pen is molded with a nose extension 64 that extends beyond the bottom edge of the front 14 and beyond the projected perimeter of the base. This bulge forwardly, which is preferably provided at least in the middle portion of the front wall, provides more space for the calf and directs some spillage from the pails outside the housing unit 10. Therefore the depth of the housing unit 10 exceeds the depth of the support area on which the housing unit is supported, i.e., the depth at half way up the front wall exceeds the depth at the bottom of the front wall.

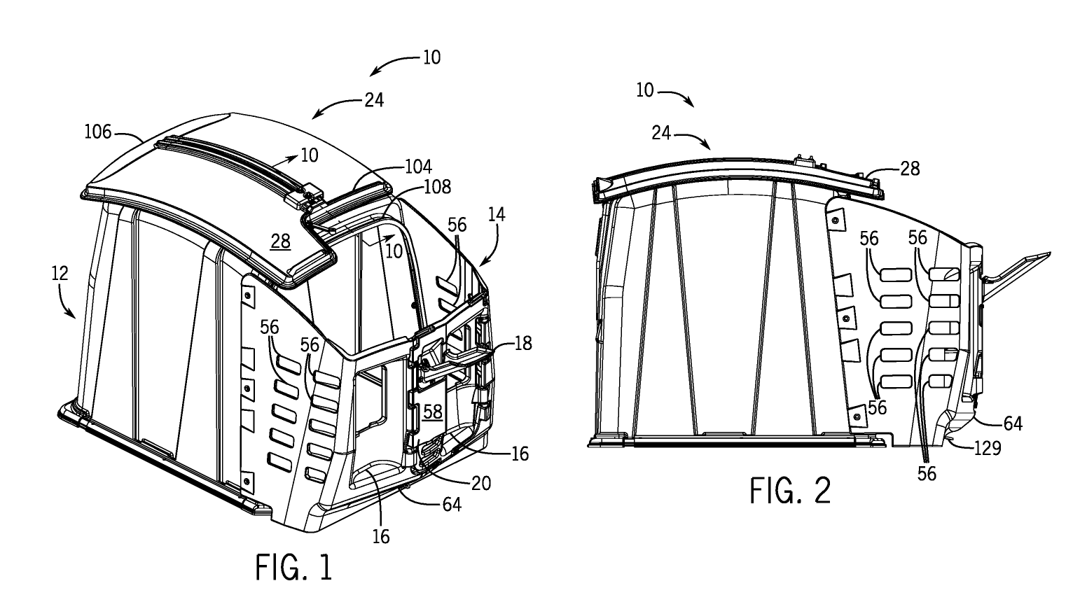

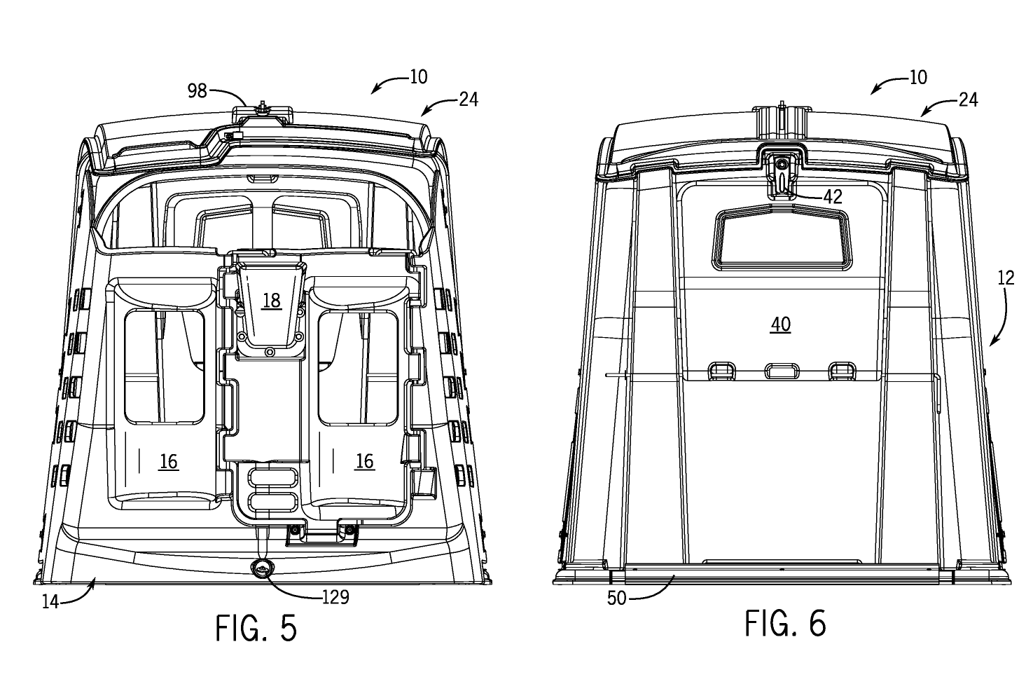

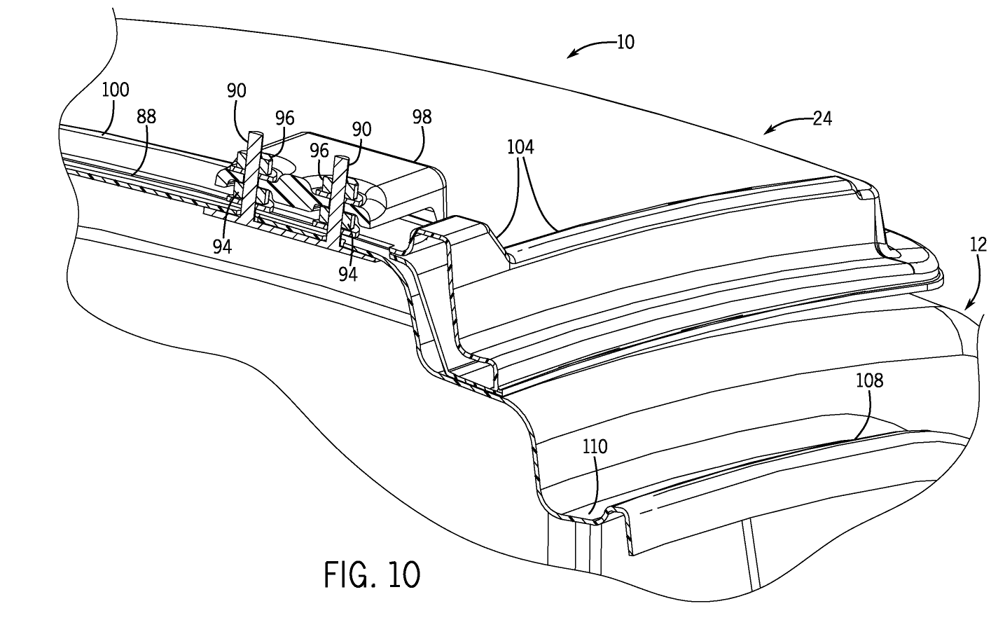

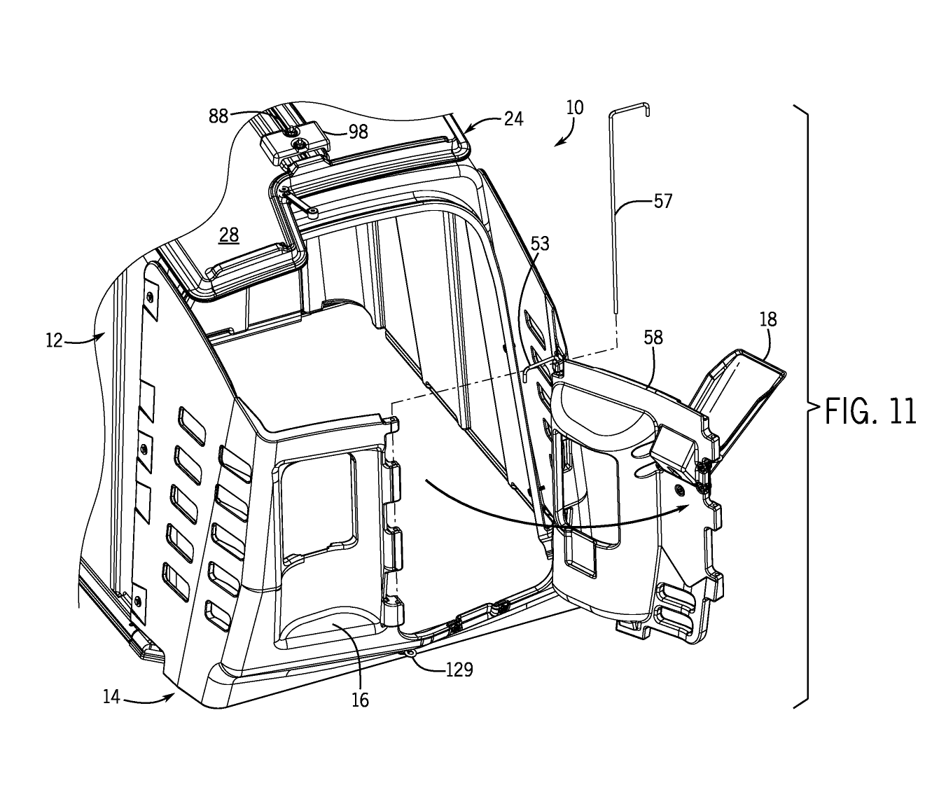

The sliding portion 24 of the roof is a bi-laterally curved double walled panel that extends the hutch's weather shielding functionality by allowing it to be positioned so as to provide the maximum protection for any given weather circumstance. The roof of the hutch is similarly bi-laterally curved. The front-to-back curve of the roofs (about a lateral axis) is shown in a side elevation view, like FIG. 2, and the side-to-side curve (about a longitudinal axis) is shown in a front or rear elevation, like FIGS. 5 and 6. Perspective view FIG. 10 shows both curvatures of both roofs. The sliding roof 24 when slid into its most forward position completely closes off the housing unit by snugly fitting over the open-topped pen front 14, which serves to protect a calf from sun, rain, and snow. When retracted back over the shelter, it serves as a double-walled layer of insulation with an air space between most of the area of the two walls of the panel to assist in keeping the shelter cooler. As stated above, the curvature facilitates accomplishing this and shedding rain expeditiously. The sliding portion 24 is presently preferably twin-sheet thermoformed, but could be blow molded or rotational molded, for example. The double wall feature of the sliding portion of the roof allows for structural strength when extended versus a single-walled structure, the ability to mold in the requisite features to enable movement, to create an outside shape or form to shed rain, and add an extra layer of insulation with an air space in between to shield from the summer sun or help retain heat in colder temperatures.

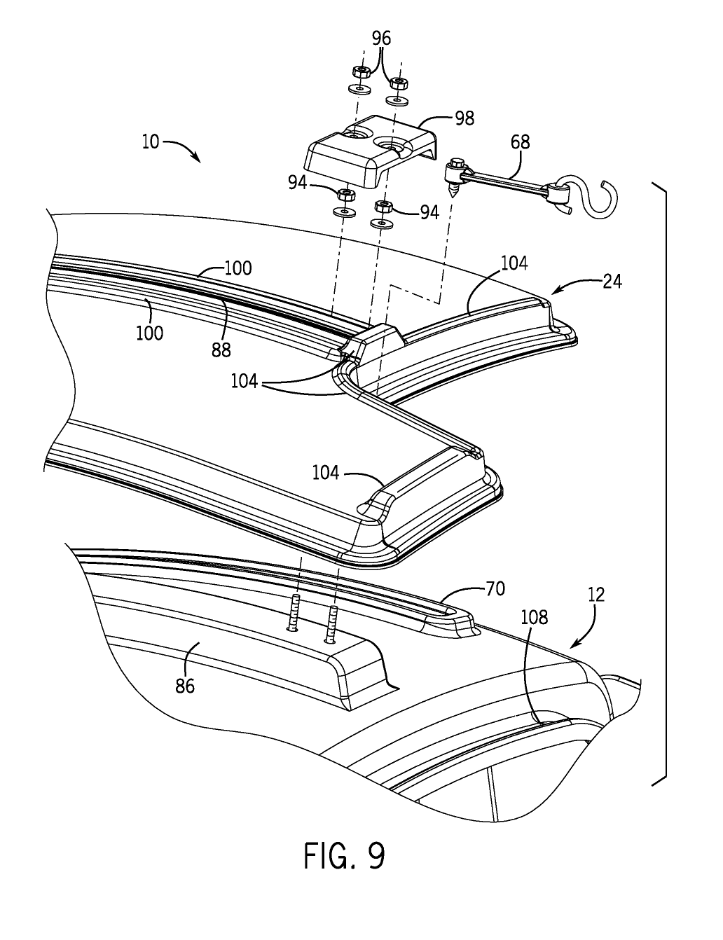

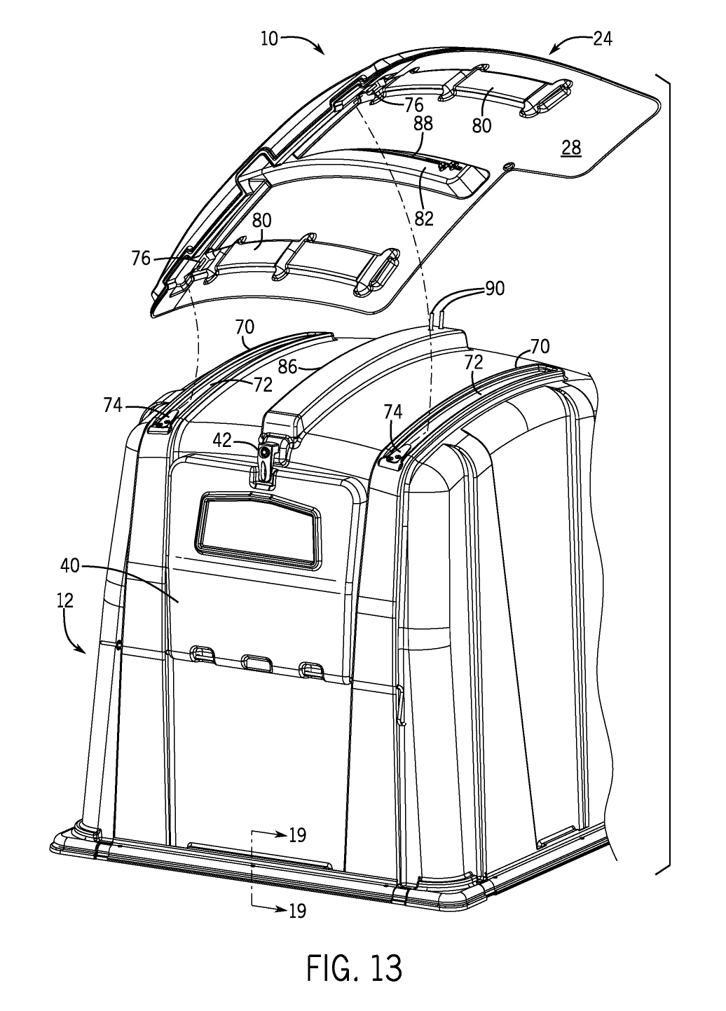

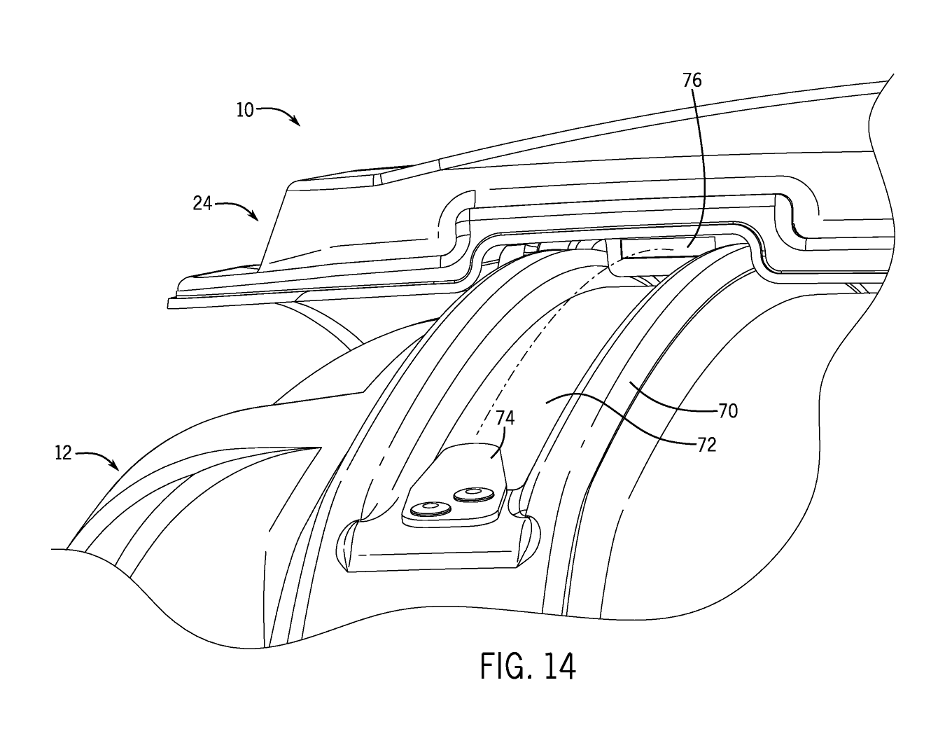

Referring to FIGS. 1-7, 9, 10, and 13-15, the mechanism that enables the sliding of the roof includes two upward ribs 70 (FIGS. 13 and 14) that are molded into the top of the hutch 12. Downwards within those ribs are shallower channels 72 that provide space for two clips 74 at the rear of the hutch 12, which are metal but could be plastic, that are fastened to the hutch and secure the slideable portion 24 of the roof tightly to the hutch 12 when the slideable portion 24 is in the fully retracted or open position. The clips 74 as illustrated are attached to the hutch 12 with fasteners, but could be molded in. This mechanism keeps the slideable roof 24 in place in severe wind conditions or when handling the product. The clips engage into and extend through respective left and right slots 76 that are cut into respective left and right projections 78 that extend downwardly from the wall of respective left and right recesses 80 that are molded into the lower wall of the double walled sliding portion 24, the recesses 80 receiving the respective left and right rib structure 70. Each projection 78 is received in the respective channel 72. The upper wall of the sliding portion 24 in the area over the recesses 80 is not recessed and provides a surface of continuous elevation in all directions to promote rain shedding.

In addition, molded down the center of the sliding roof 24 is a long, upward projecting channel 82, that runs longitudinally parallel to the sliding direction and between the recesses 80, reinforced by several additional ribs, which nests over a correspondingly shaped projection 86 molded into the top of the hutch 12. A slot 88 is cut into the sliding roof 24 that allows a pair of studs 90 welded to a plate 92 and fastened to the top of hutch 12 with nuts 94, with a sliding clearance between the washers beneath the nuts 94 and the roof portion 24. The studs 90 protrude through the slot 88 with a sliding clearance and nuts 96 and associated washers secure a U-shaped molded cap member 98 that receives raised ribs 100 molded into the top wall of the sliding portion 24, one on each side of the slot 88. Member 98 provides the mechanism to secure the front of the sliding roof to the hutch 12. When the sliding portion 24 is fully extended forward over the front of the housing unit it is secured there with an elastic hook device 68 (rubber bungee cord) as described above. This provides a four point fastening mechanism in the retracted position of the sliding portion 24 and a three-point fastening mechanism when extended that secures both the front and the rear of the sliding portion in both positions.

Located at the front of the sliding roof 24 is an upwardly projecting and laterally extending rib 104 that channels rain water off to the side, rather than having it drip into the front pen area. The rib 104 runs continuously from end to end and includes elevated portions with some portions that run laterally and one portion along the inner edge of the extension 28 that runs longitudinally so that rain water flowing forward on the roof portion 24 is channeled to one side or the other for substantially the entire width of the roof portion 24, and everywhere between the ends of the rib 104. At the rear of the roof is another upwardly projecting and laterally extending airfoil looking rib 106 that tapers downwardly toward its end that also channels rain water off to the sides, preventing it from running down the back and overwhelming the rain protection molded into the rear vent. A flange 108 is molded into the front of the hutch 12 that forms a gutter 110 that channels rain water coming down the front side of the hutch 12 off to the sides.

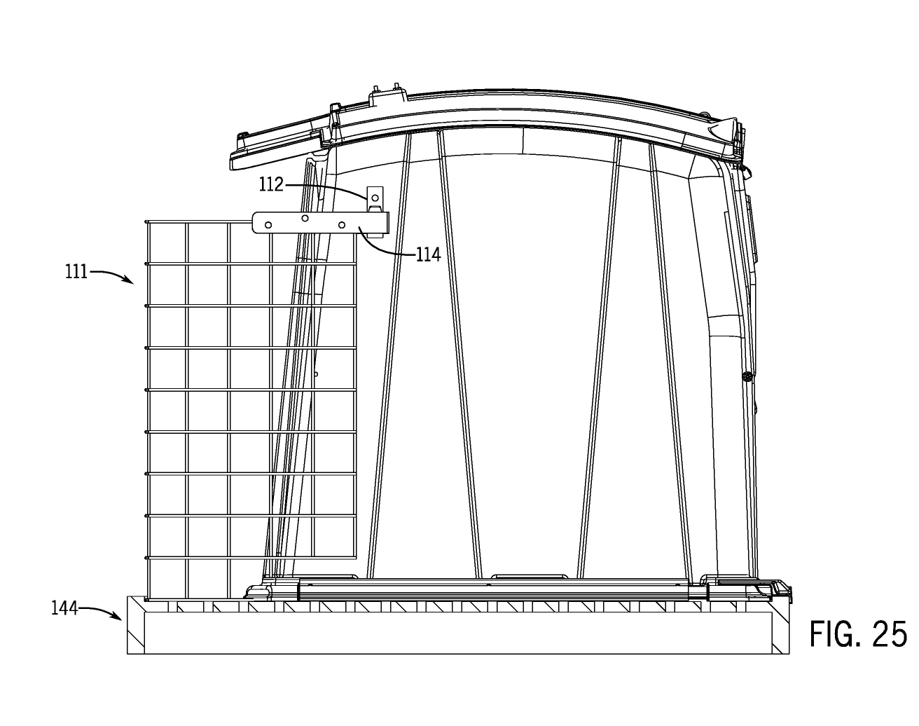

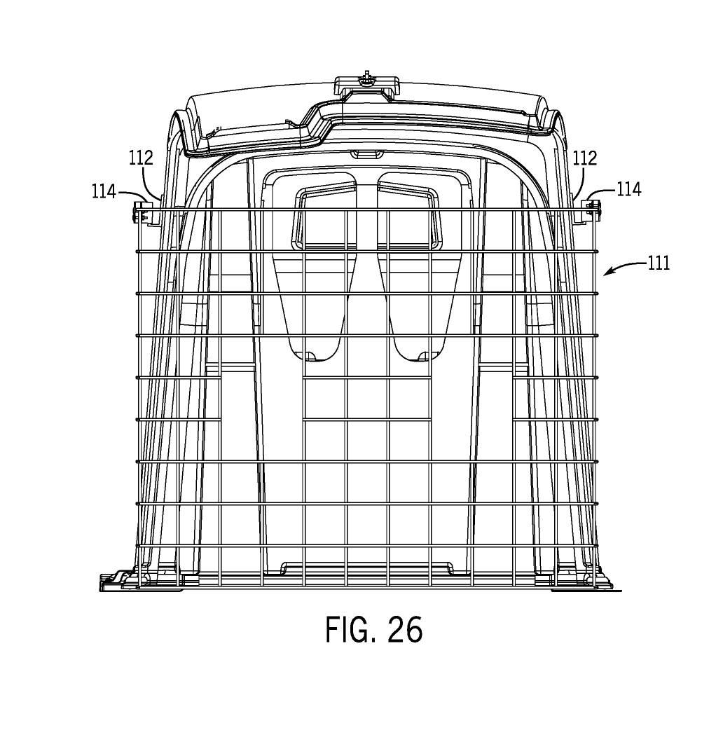

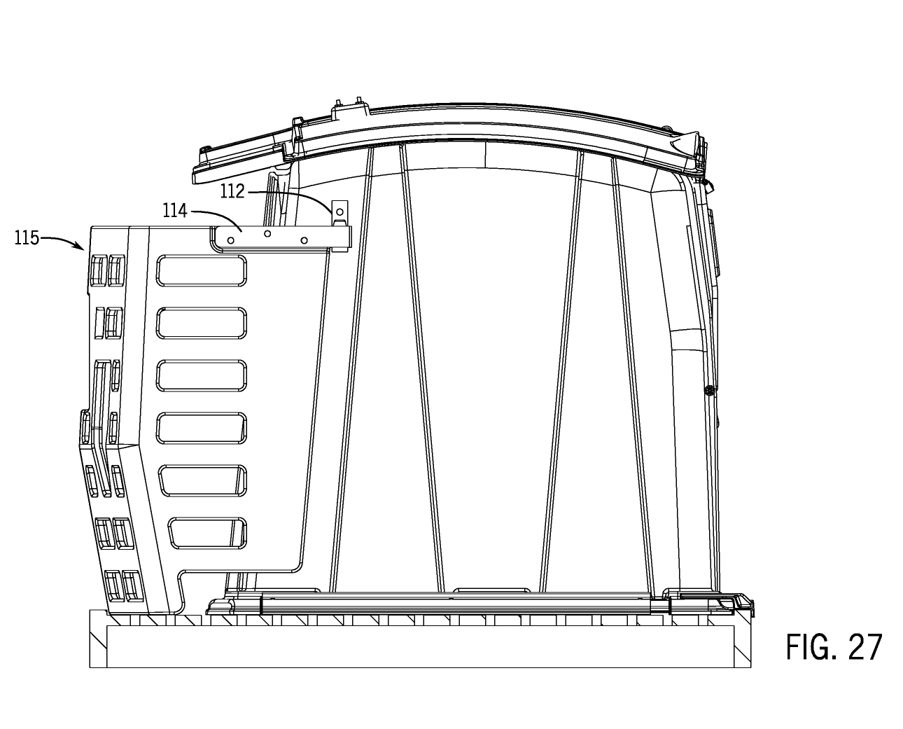

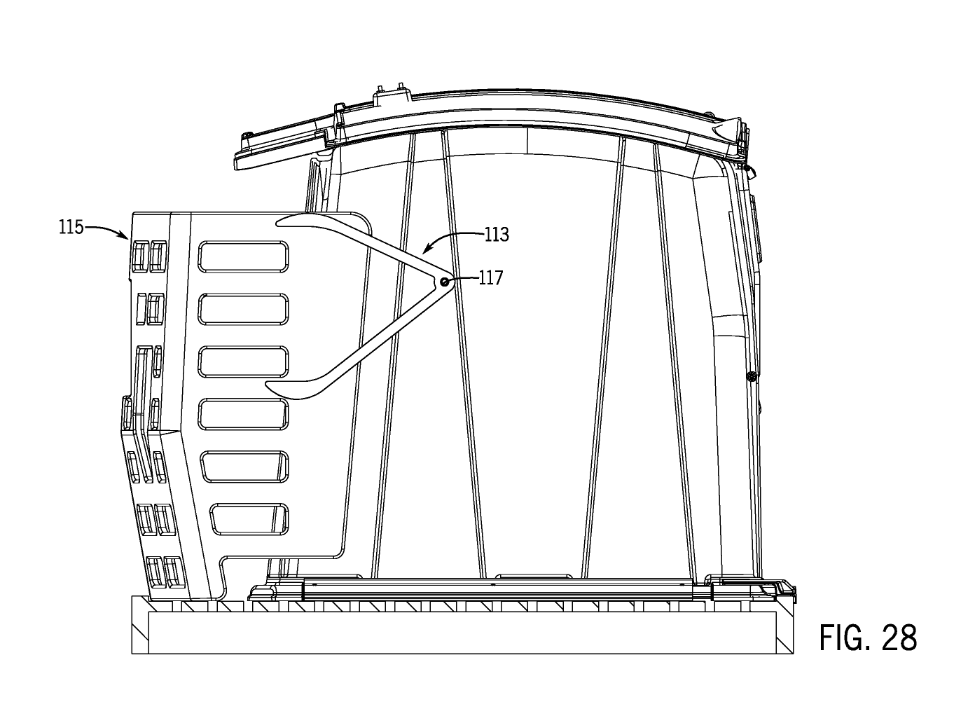

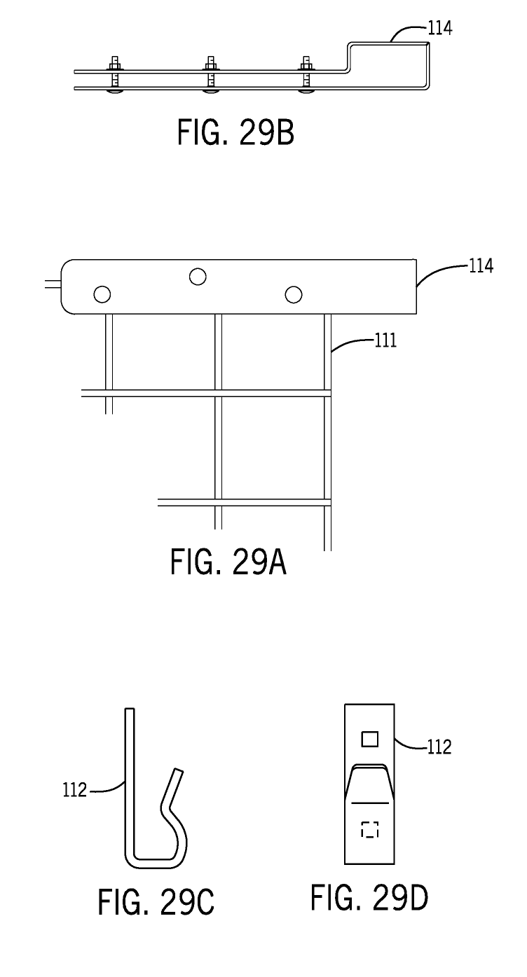

Referring to FIGS. 25, 26 and 29A-B, an alternative way of enclosing the front of the housing unit 10 is with a metal pen either designed or fabricated to fit, with some of the same features as the double-walled plastic front 14. Pail and bottle holders and door (or not) can be cut and bent starting with a standard prefabricated wire fence panel 111—in that case there would be no door. Such a metal front can be attached at least three different ways: bolted on similar to the plastic front pen; with a hook 112 and eye 114 to make it easy to remove (See FIGS. 29A-D, with the sheet metal hook 112 fastened to the hutch and the sheet metal eye 114 attached to the wire fence 111 pen as illustrated, or can be used with a plastic front pen 115 as shown in FIG. 27); or with a pivot device 113 that allows the front 115 to tip up over the hutch about a pivot axis 117 as illustrated in FIG. 28, shown in connection with a plastic front. Additionally the plastic front can be attached in all three manners also. If a door is included in the pen front, metal or plastic, that may complicate the hook-and-eye connection and the swing-up connection to an extent such that the rapid removal or swing-up functions may not be needed, but could still be provided, and would make cleaning and moving simpler in some cases.

The prior art industry standard wood base dictates the size of many presently available calf housing units. It is estimated that there are in excess of one million, some estimates are as high as two million, “holes”, as they are commonly defined in the industry, more properly calf positions, built of wood. Commonly there are three positions present in one combined unit with a base size of 8′ wide and 5′ deep—each position approximately 32″ wide minus the wood wall thickness. This set of three positions on one common base is known as a calf crate. The 8′ dimension was predicated by the 8′ length of a sheet of plywood, and the 5′ depth by the ability to rip multiple plywood sheets to make roof sections and leave some open space to the sun for the calves. Some calf raisers have maintained the same 8′ by 5′ base but sectioned it into two positions. Calf housing units of the invention could be made to fit the two position sizes, the three position sizes, or any size desired by customers within reasonable limits.

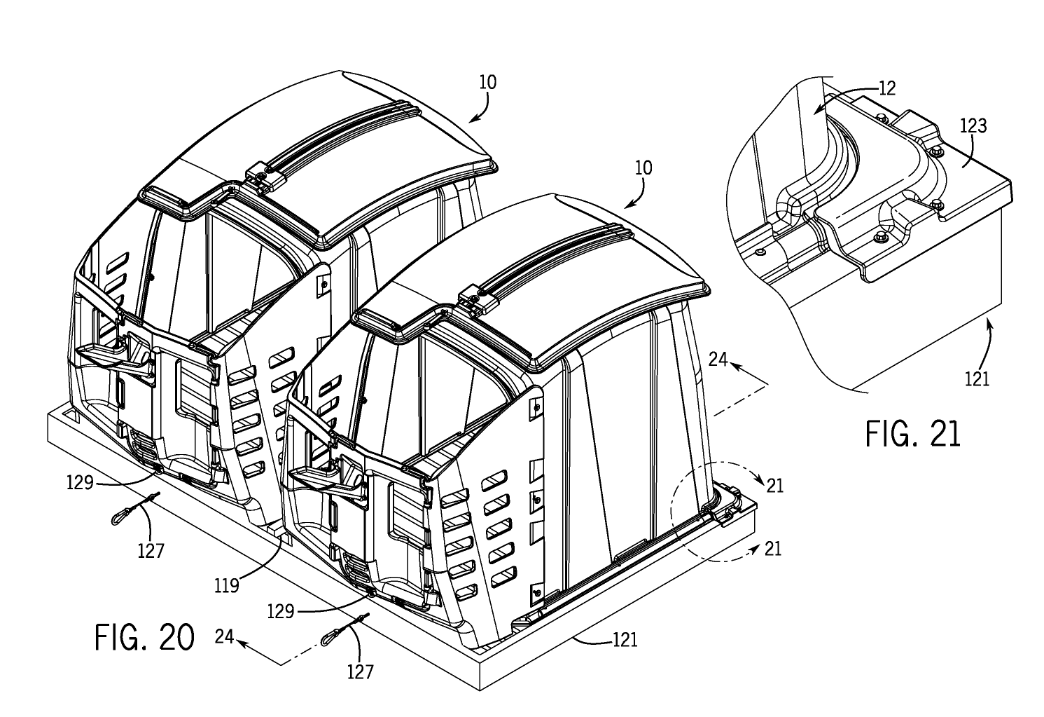

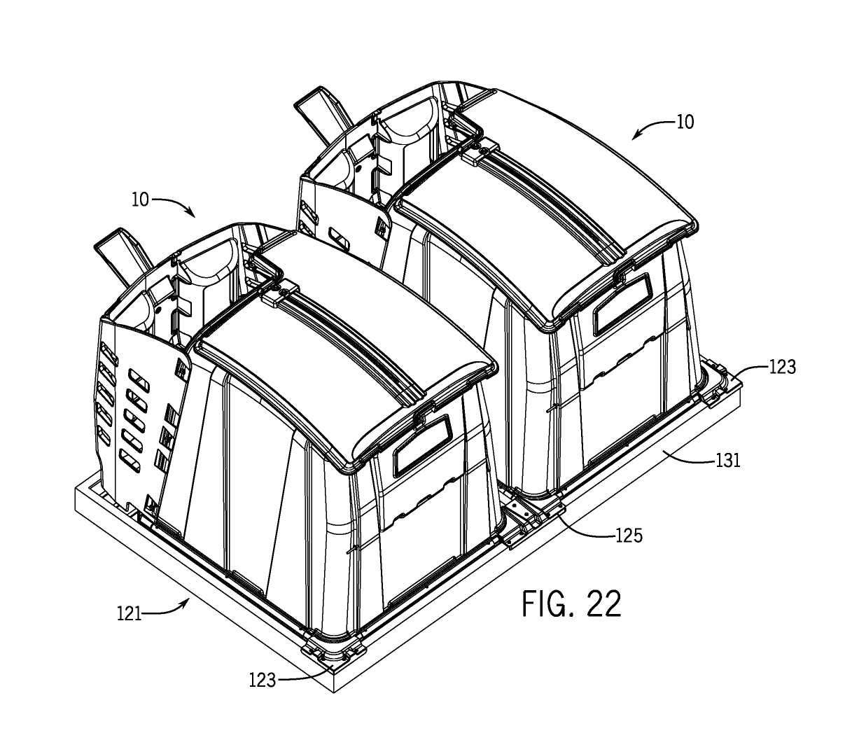

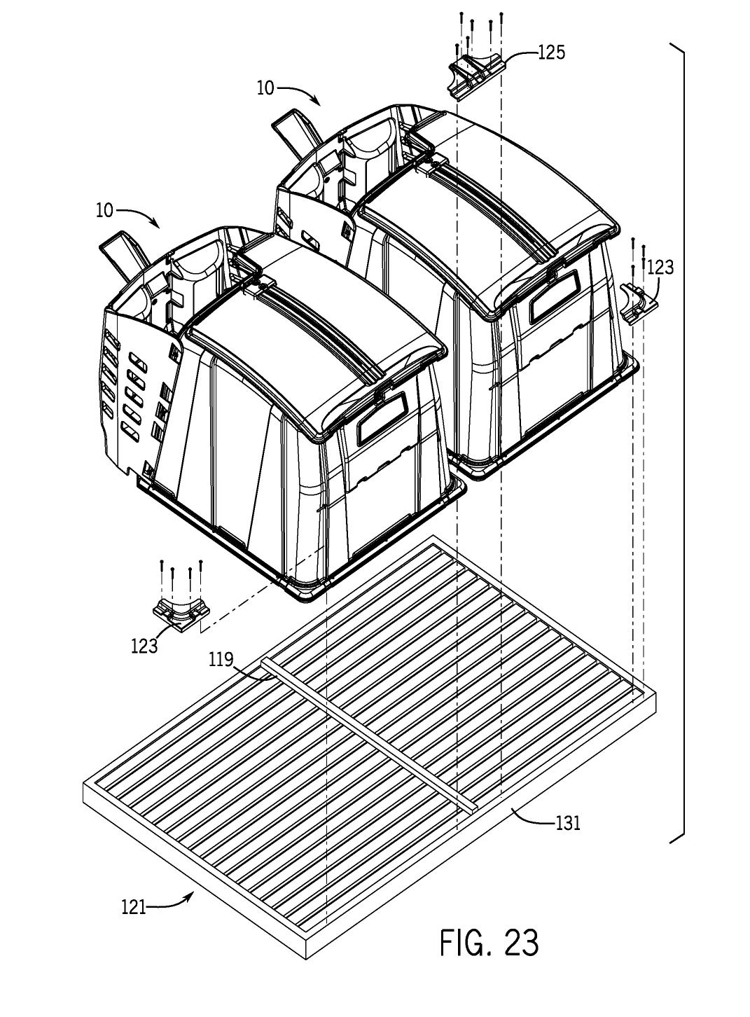

To facilitate the positioning of the housing units 10 described above, a wooden strip 119 (FIG. 20, a standard 2x2) may be installed down the center, between the two housing units mounted on an 8′×5′ base 121, front to back. Additionally the hold down devices described below could be installed.

To secure the hutch to the base in high winds, and secure it against displacement by a rowdy calf, three molded parts 123, 125 (two corner hold-downs 123 and one center hold-down 125) are installed on the base at the rear corners of the housing units 10 and two elastic hook-and-eye devices 127 are fastened to the front of the base, near the center of each housing unit 10, that engage an eye 129 that is fastened to the front of each housing unit. The rear molded hold-downs 123, 125 could be twin-sheet molded, but could be single sheet. They can form fit the corners of the hutch. Two corner hold-down members 123 are fastened at each outer corner with screws and the center hold-down 125 that engages both inner corners of the two housing units 10 straddles the rim board 131 on the back of the base 121 and the center board 119.

The bases can be elevated off the ground by using supports of any suitable material or devices that will support the weight of the system. In certain climates, for example with hot summers and cold and snowy winters like the northern areas of America's Southwest, the bases are positioned on concrete blocks. In the winter the risers/blocks are removed such that the bases are tight to the ground to inhibit drafts from the bottom and provide a warmer shelter for the calves.

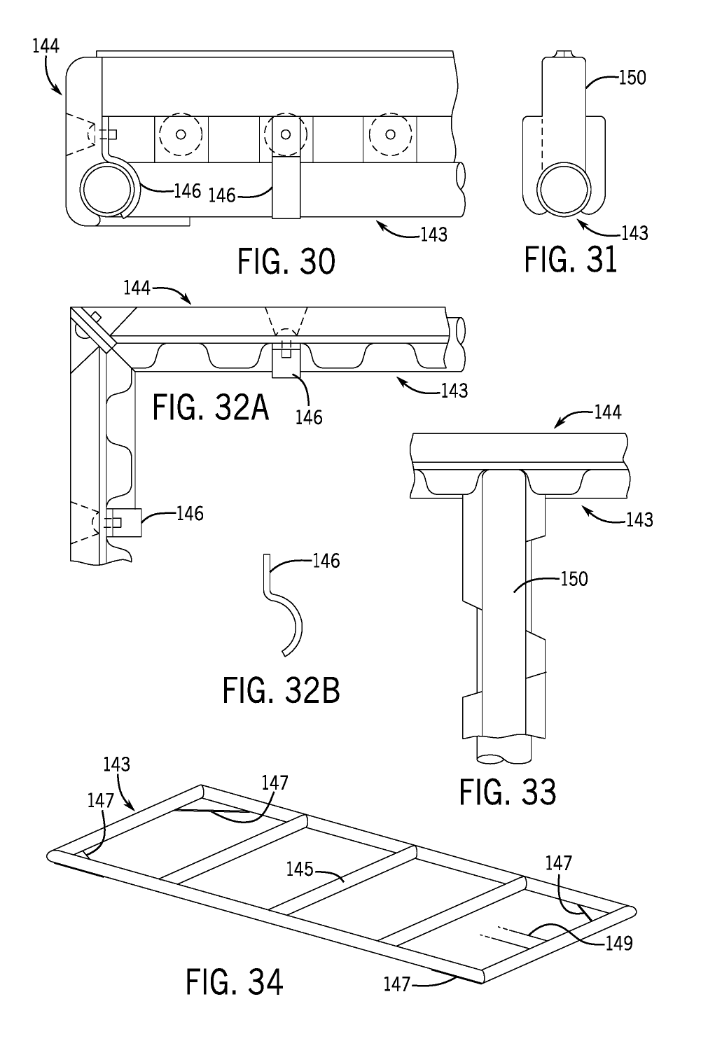

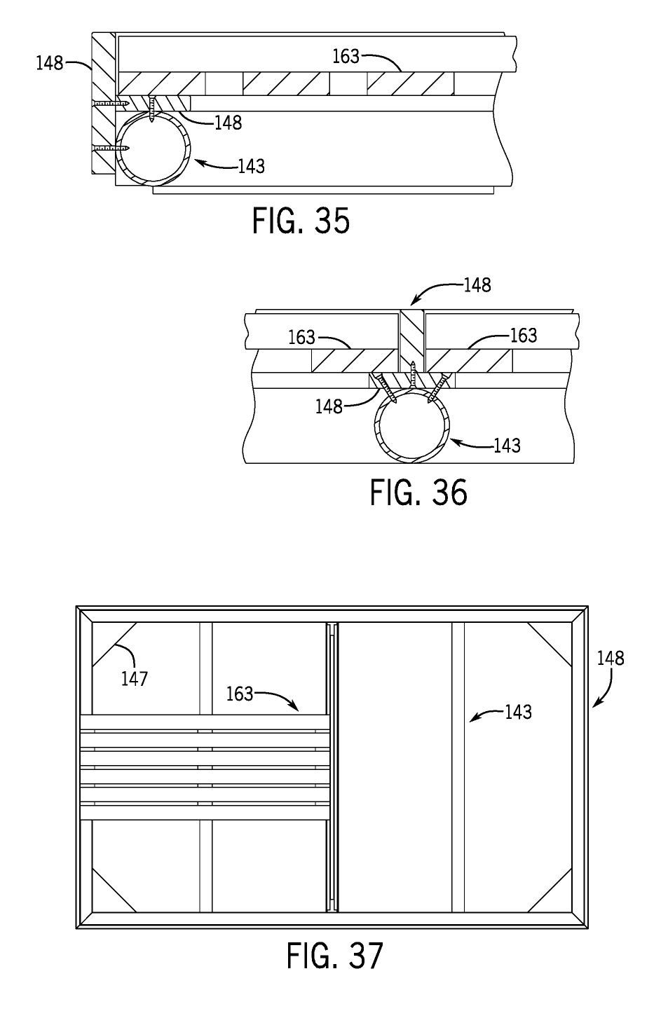

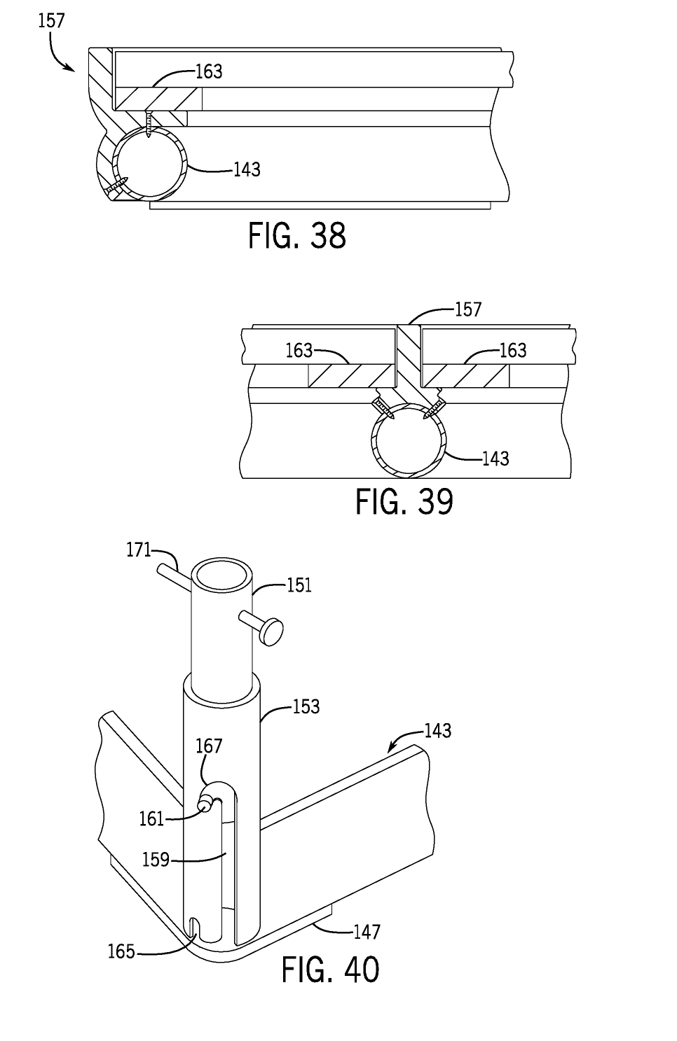

As an alternative to the existing prevalent wood bases, a composite steel and plastic base could be provided. This would have a steel substructure for strength and rigidity and plastic components that provide closure to the ground when applicable and positioning for the hutch and floor sections of the housing unit. A steel member 143 could be a rectangular-shaped, welded steel frame of pipe, tube, or other structural shape (See FIG. 34) with at least one centered front-to-back member 145 of similar material. The overall frame size could be slightly smaller than the existing wood bases. At each corner a triangular plate 147 as illustrated could be welded on to reinforce and provide a footing for placement on the risers, which could be concrete blocks. There could be another steel member 149 welded side to side, the 8′ direction, placed slightly back of center to allow picking up the entire unit with a forklift truck that has fork tines less than 5′ long. Surrounding the pipe and extending slightly above it, to position and support the hutch, plastic members of appropriate shapes and sizes could be provided. Additional plastic members or extensions of the surround above the frame could be provided to position and support flooring for the housing unit which could permit drainage through the flooring. Three possible variations are as follows:
(1) Plastic Lumber and Steel Hybrid Base: The steel frame 143 surrounded and covered with commonly available plastic lumber 148 (FIGS. 35-37) attached with screws or other appropriate fasteners. Floor tiles 163 could be placed on the plastic lumber frame.
(2) Custom Extruded Plastic and Steel Hybrid Base: The steel frame 143 surrounded and covered with custom shaped extruded members 157 of a plastic material (FIGS. 38-40) similar to that of plastic lumber but compounded with materials that could lower the cost and increase stiffness.
(3) Molded Plastic and Steel Hybrid Base: The steel frame 143 surrounded and covered with custom shaped molded member(s) 144, either twin-sheet thermoformed, blow molded or rotational molded as illustrated in FIGS. 30-33. Brackets 146 can be used to attach the frame 143 to the member(s) 144. If twin sheet thermoformed, the twin line can migrate as illustrated in FIG. 33. A center divider 150 can also be provided as illustrated.

Additionally, a hybrid composite base could have built-in adjustable risers, likely positioned on the outer corners of the unit, which could employ telescoping components that are secured in position by pins or other fasteners as illustrated in FIG. 40. One idea is a telescoping tube 151 in a tube 153. The inner tube 151 would be the riser with a foot on the bottom and the outer tube 153 would be a guide and would be attached at each corner of the base on which the housing units are supported. The outer tube 153 is slotted part of the way with a slot 159 and the inner tube 151 has a pin 161 (or pins) that ride in and can be supported by the slot 159. When the base is elevated, the riser 151 is rotated so the pin 161 is dropped in the slot 159 to a lower position relative to the guide 153 whereat a notch 165 in the bottom of the outer guide tube 153 is provided to receive the pin. To drop the base to the ground, the riser 151 is rotated with the pin 161 in the slot 159 so it can slide up into the guide tube 153 and be rotated to engage the pin 161 in the notch 167 at the top of the slot 159. There could be a pin 171 at the top of the riser 151 that is positioned above the guide to keep the riser 151 from falling out when moving the base 143.

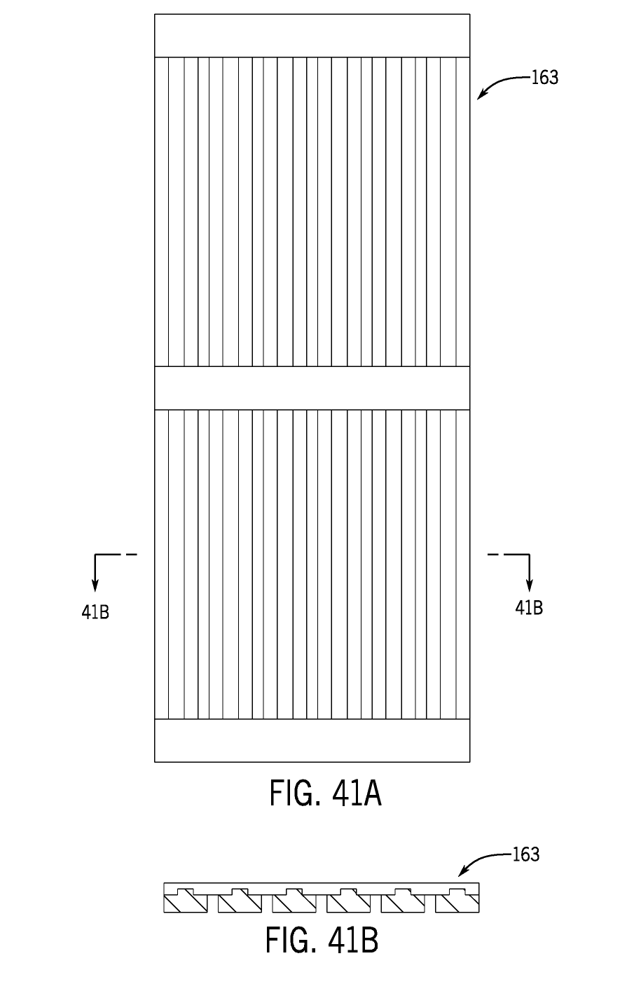

Spanning the frame 143 from the center 145 to the side edge could be open grid floor tiles 163 as illustrated in FIGS. 37, 41A and 41B. There could be three floor tiles per housing unit, as illustrated in FIG. 37. Each floor tile 163 is multi-slotted for good drainage through it and supports the animal so as to allow excrement to pass through. Given the existing size of the wood units as 8′ by 5′ and the future likelihood that a majority of raisers will have 2 housing units per base, the width of these floor tiles will be half the width of the complete base minus the thickness of the positioning members. The industry is slowly embracing more space per calf such that there is a likelihood that future housing units will be deeper (front to back) than the present 5′ dimension (60″). To accommodate the present sizes of standard bases, the tiles could be made 20″ deep, so three tiles would be used to provide the 5′ depth dimension. If in the future a deeper base is desired, a fourth floor 20″ deep tile could be added to provide a depth of 80″ deep total.

There will likely be calf raisers that want to stay with three units on the existing 8′ by 5′ base size. It would require different narrower tooling for all components but is possible. It is also possible to use three of the wider housing units on a wider base.

Another possibility is a combination hutch/pen that is deeper front to back than the 5′ existing dimension. A base could be provided such that making different sizes is possible, possibly enabling adding an extra tile as described above. In such a case, the housing unit components would have to be made longer. There are at least four possibilities for doing that: 1) a longer hutch, 2) a longer front pen portion, 3) both components longer, and 4) a separately molded extension that fastens between the front pen and the hutch.

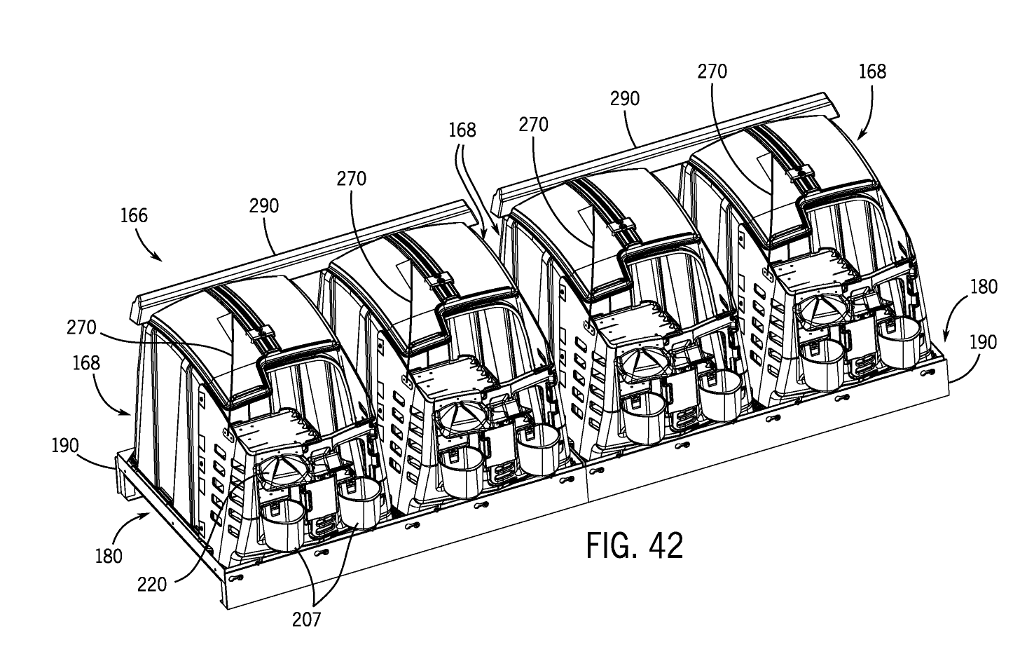

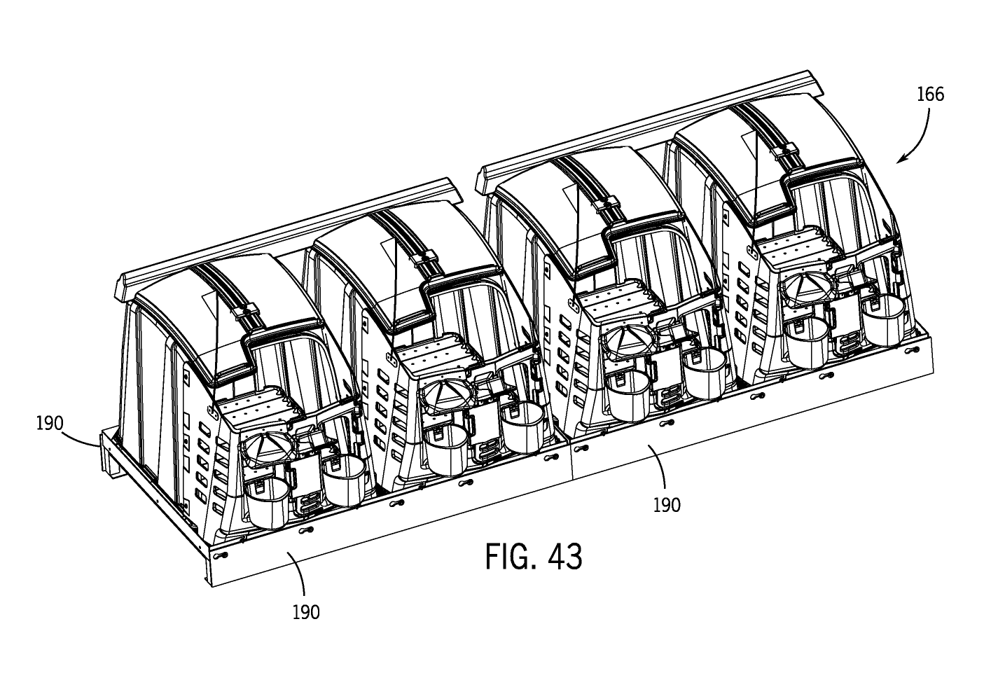

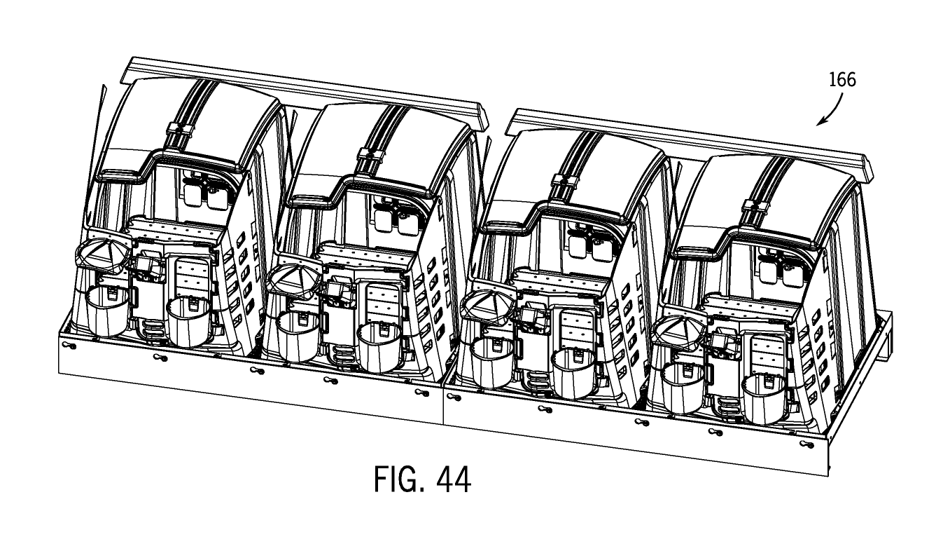

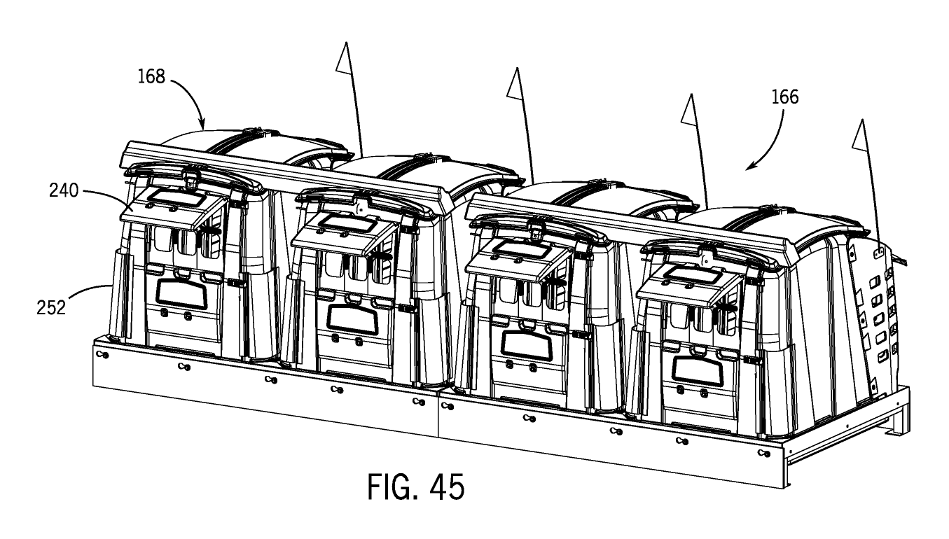

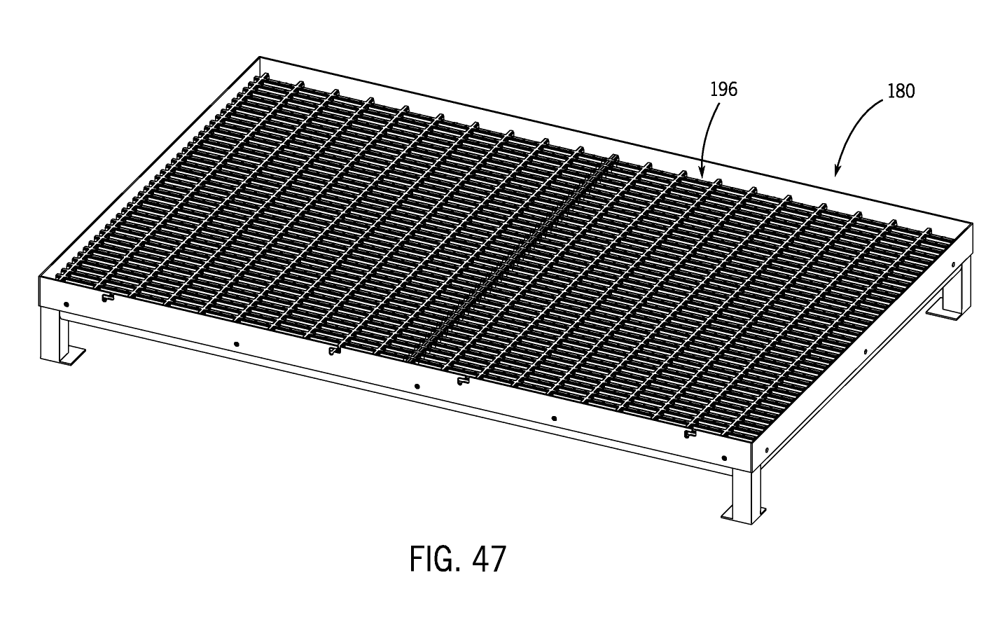

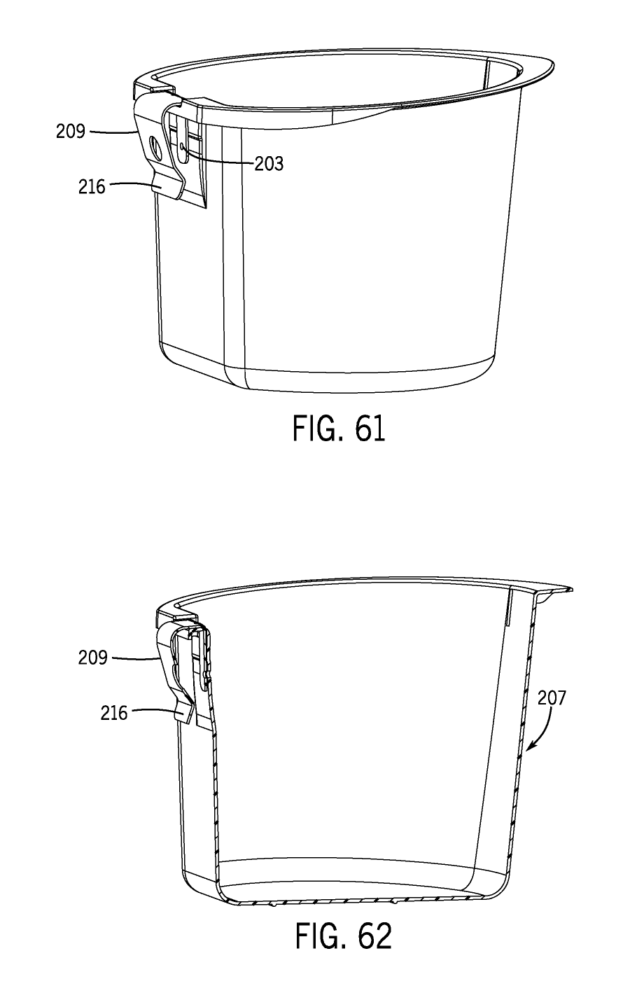

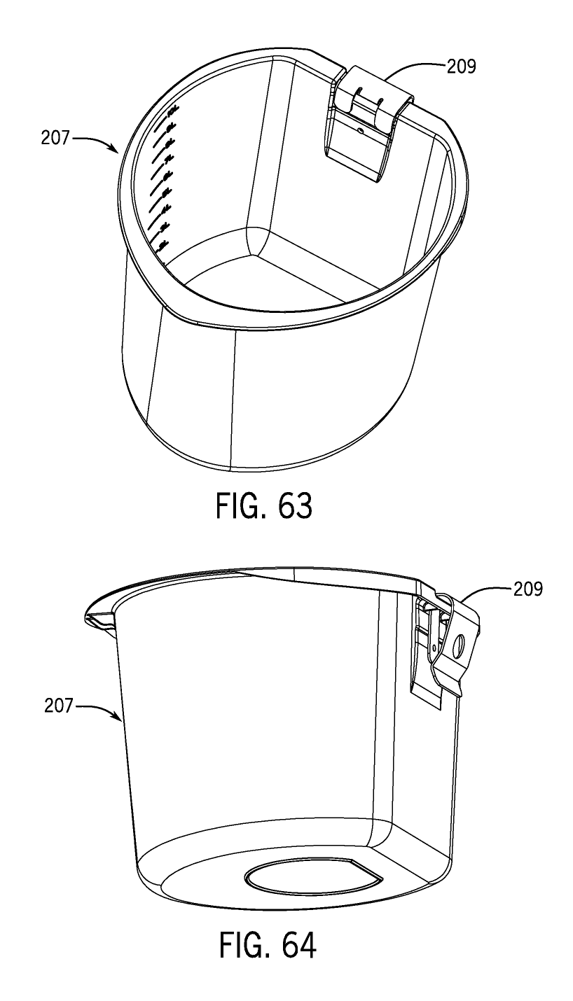

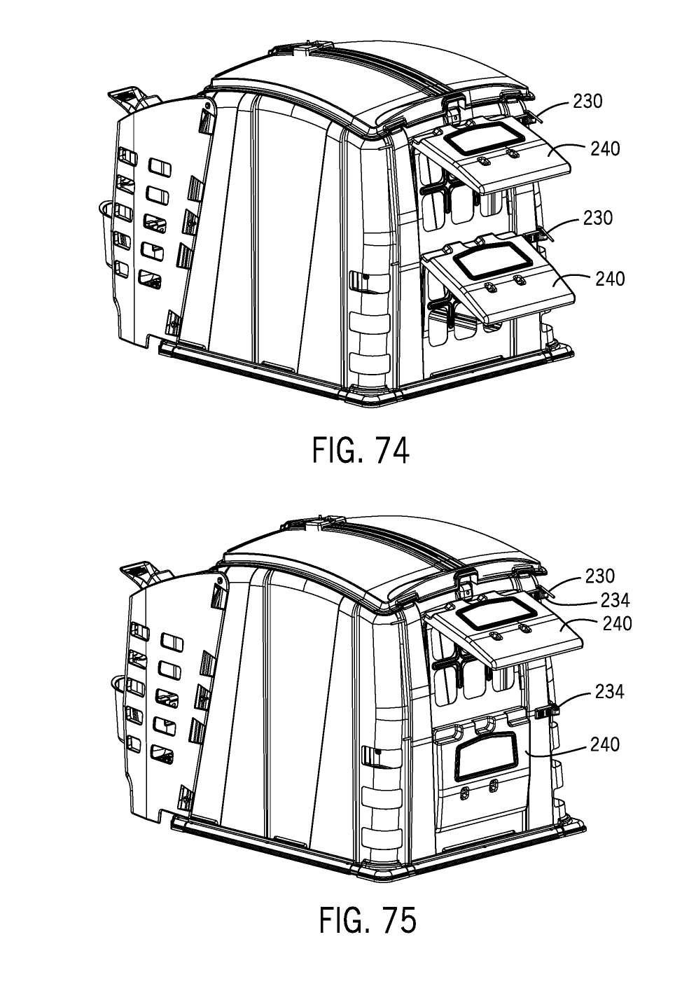

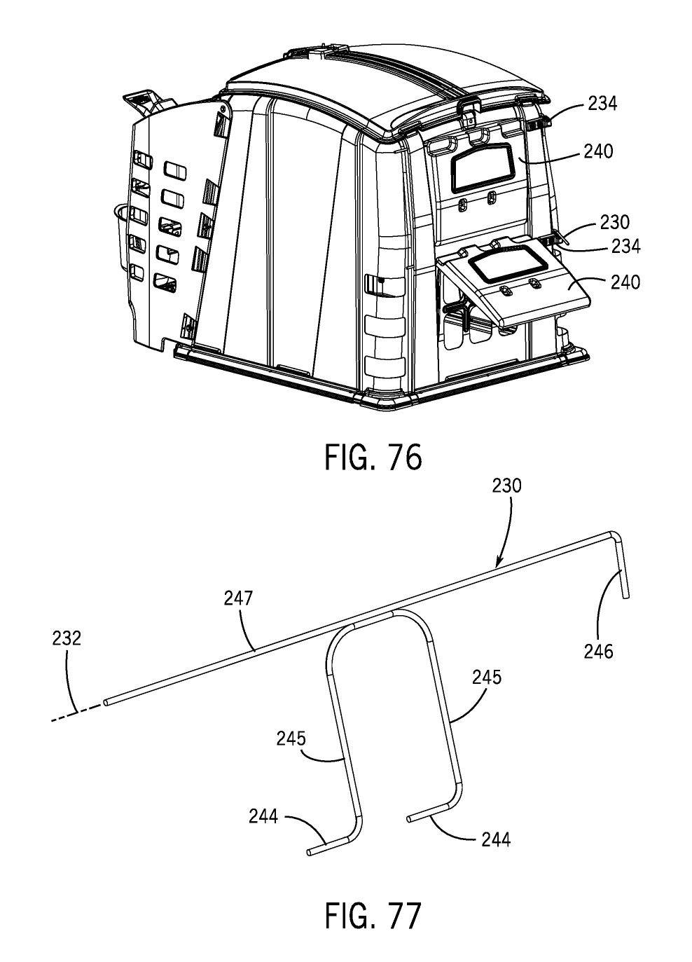

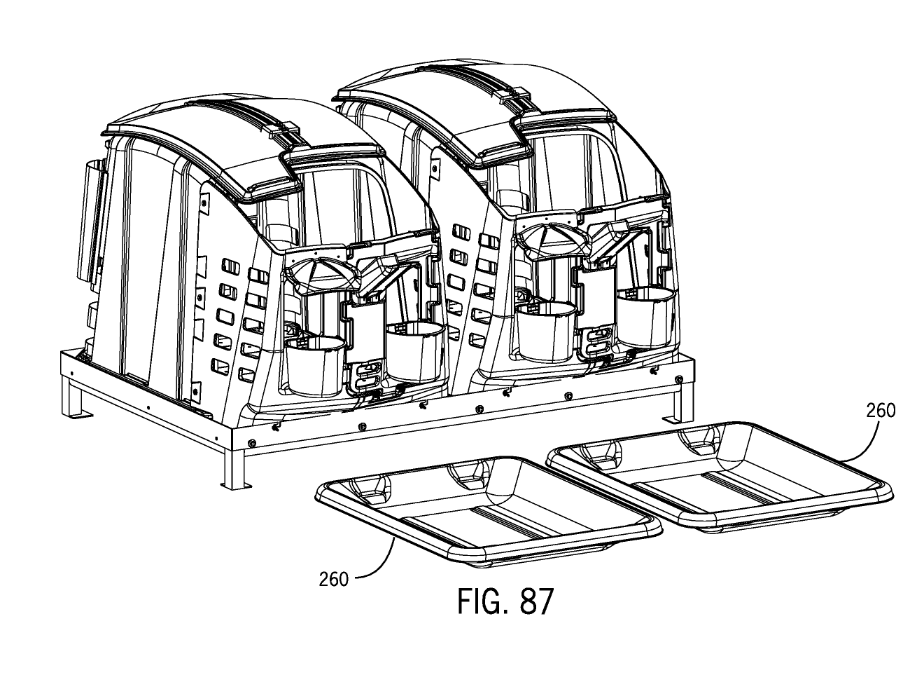

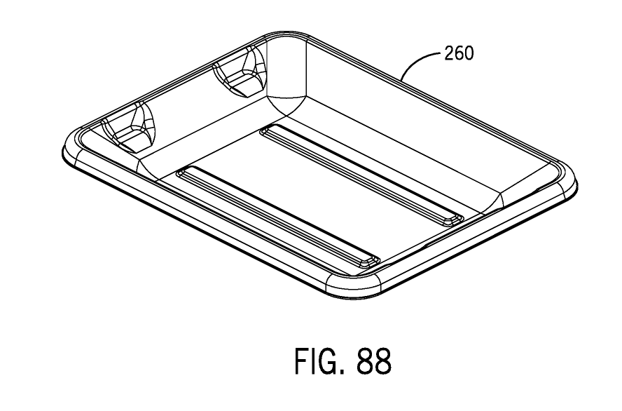

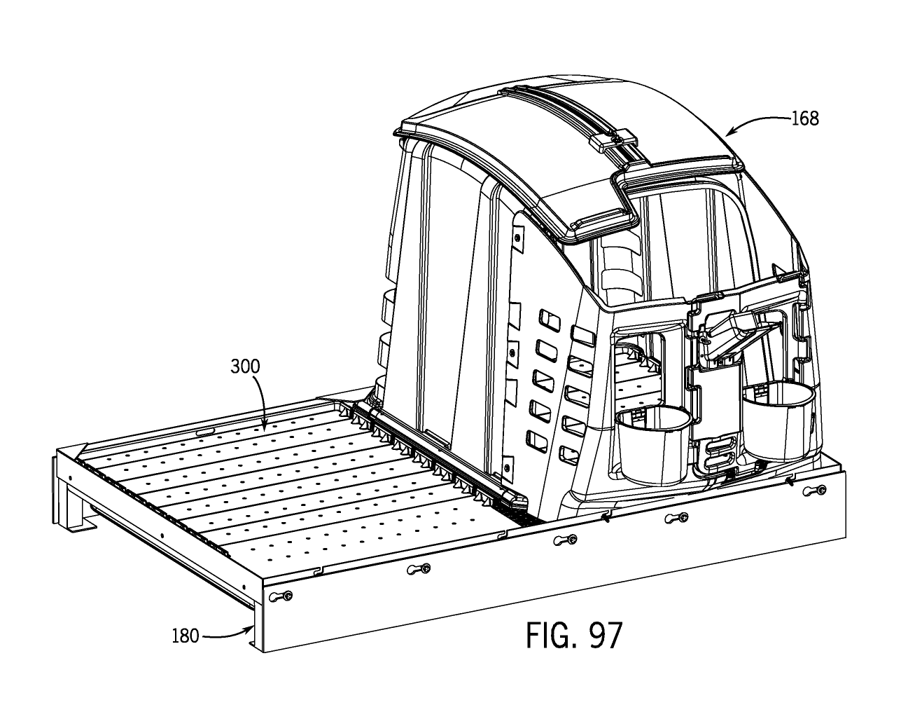

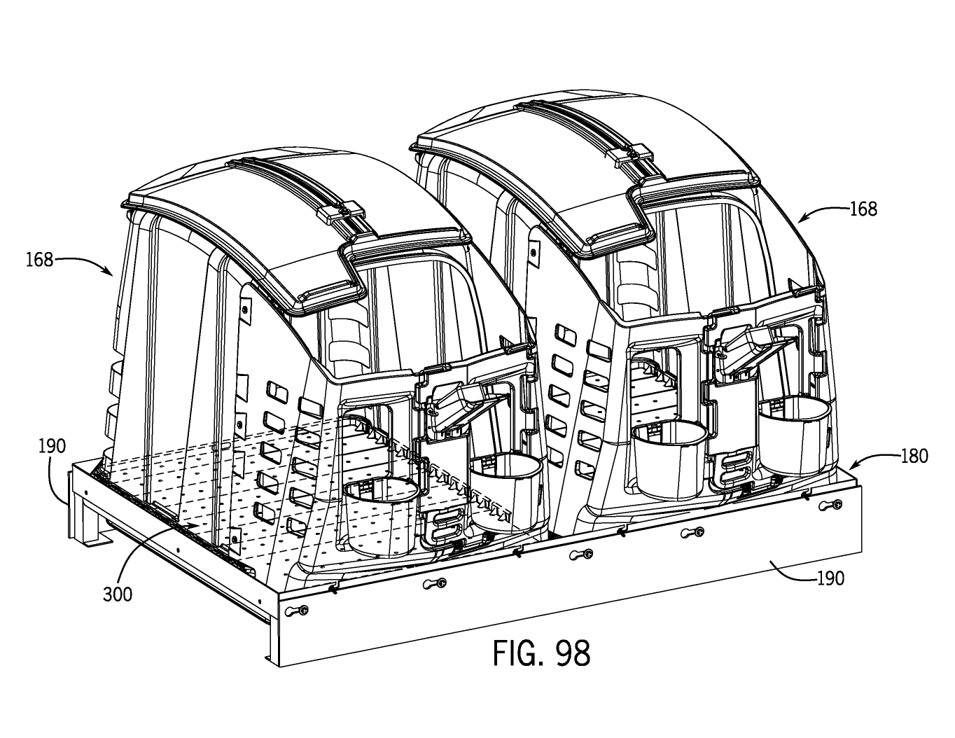

Following is a description of additional features of an alternate calf system 166 of the invention including alternate housing units 168 as shown in FIGS. 42-98.

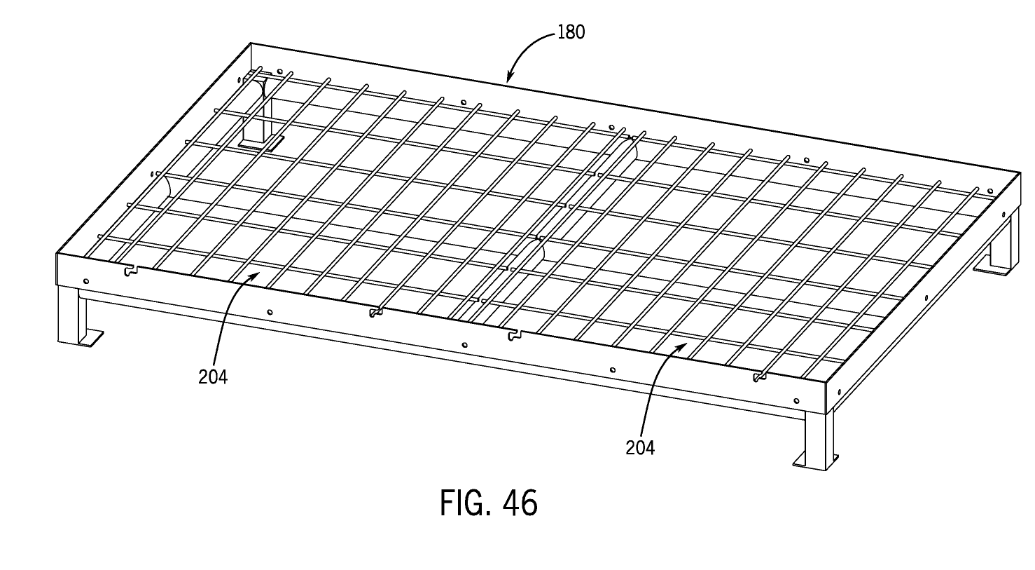

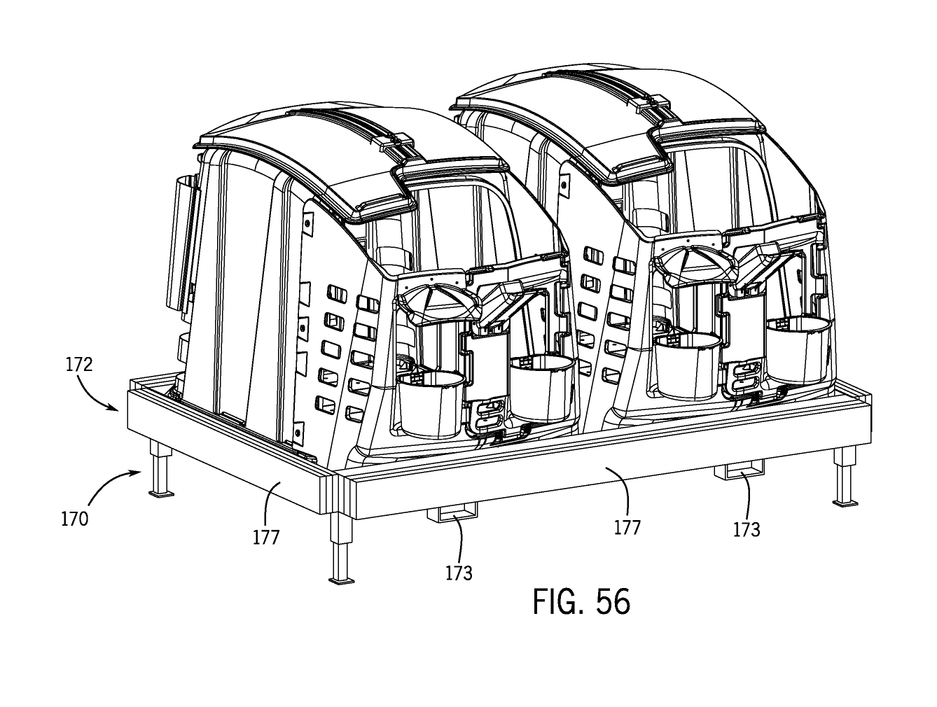

Alternative elevating bases are disclosed (FIGS. 46-54 and 56) including a tier 1 base 170 (FIG. 56) and a tier 2 base 180 (FIG. 46). The difference in the bases is that the tier 2 base 180 does not have telescoping adjustable height legs or fork lift pockets like the tier 1 base 170. To get the desired year round results, the base needs to provide ventilation from beneath in the summer and eliminate drafts in the winter. Additionally, the base enables the relocation of calf housing systems at the end of the rearing cycle . . . either 60 or 90 days.

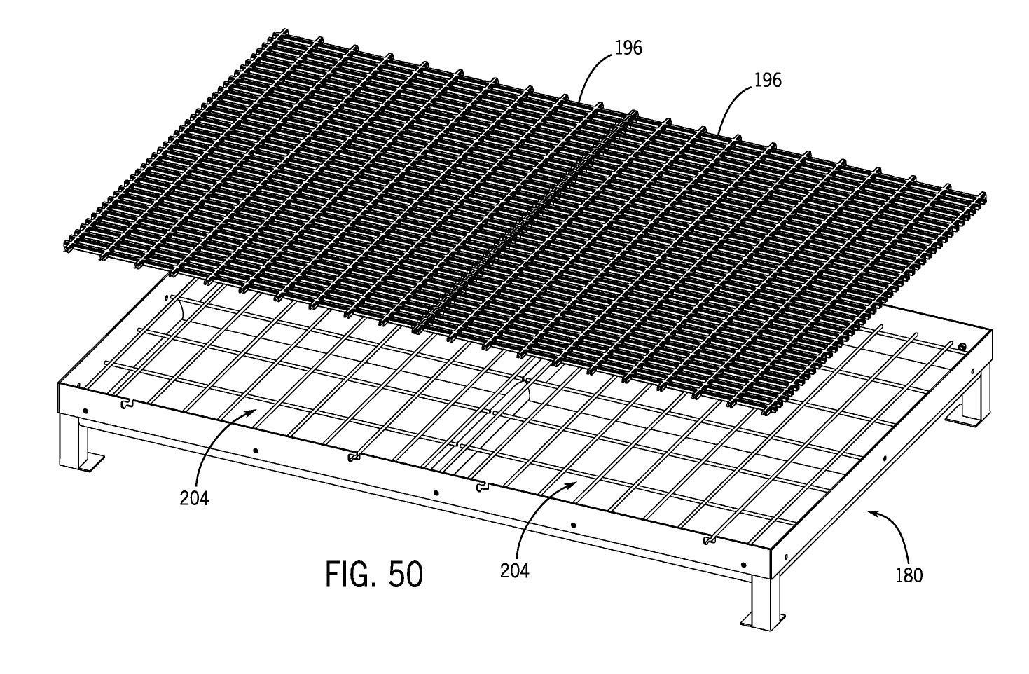

Bases can be constructed of 2-½″ steel piping (either round or rectangular cross-section) in 8′ lengths as the basic frame structure (FIG. 46), to which steel edge sections are welded at the perimeter edges and a steel rod support grate 204 can be welded to support a soft plastic floor grate 196 (two each per base, FIG. 50).

Two adjacent bases will be able to be connected together (e.g., bolted end to end). This will enable two bases (or four hutches) to be relocated at one time. Forklift pockets 173 (FIG. 56) can be provided on each tier 1 base 170 so that up to two bases can be bolted end to end to one another and lifted and moved by a single forklift truck at one time. The same could be done with two tier 2 bases 180. There can be two forklift pockets on a single base to accommodate moving a single base. Forklift pockets are not absolutely required to lift the bases and so they may not be provided, as on the tier 2 base 180.

The tier 1 base 170 has a floor height of 18″ with the legs extended. Elevating the base on legs eliminates the need to elevate them on mortar blocks in the summer time. This allows for 8″ for a manure catch pan and 6″ of ventilation clearance plus the 4″ top base structure height. The legs on the tier 1 base 170 (FIG. 56) can telescope to enable raising and lowering depending on the season. The tier 2 base 180 has a fixed height of approximately 10″. The legs on the tier 2 base are not adjustable.

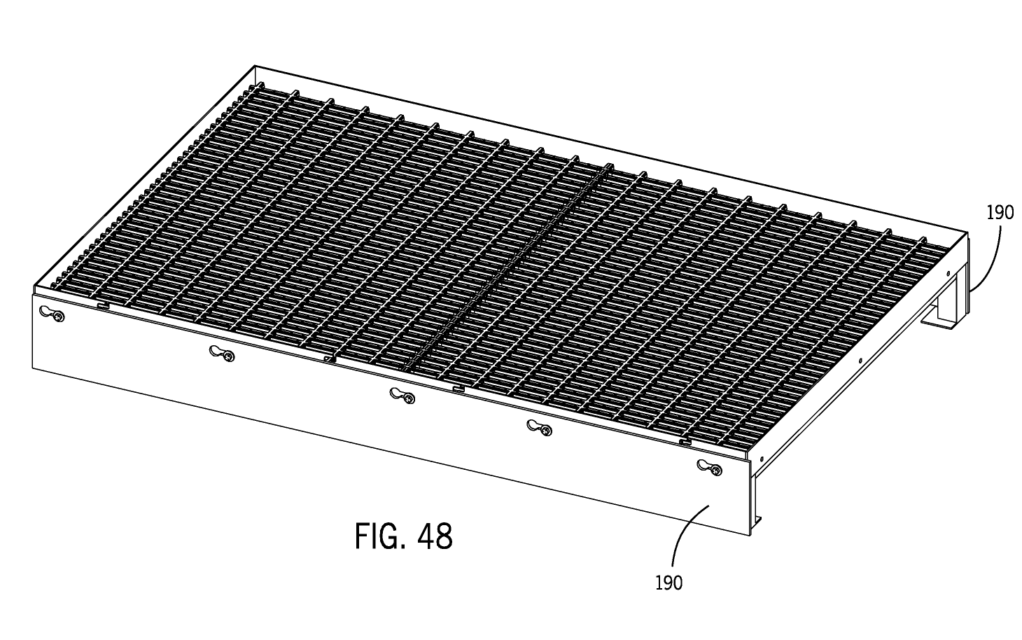

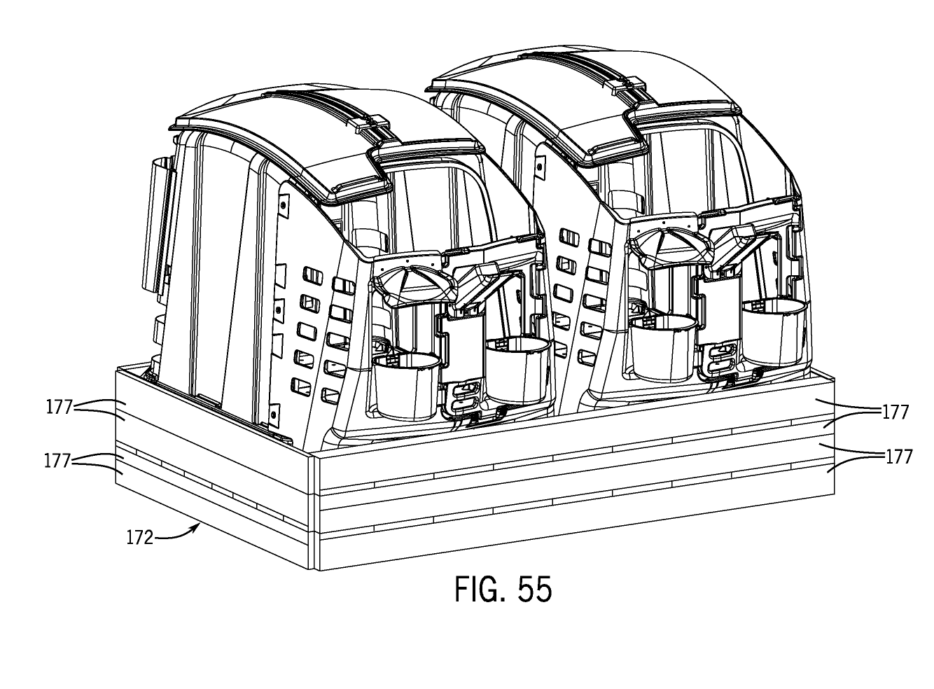

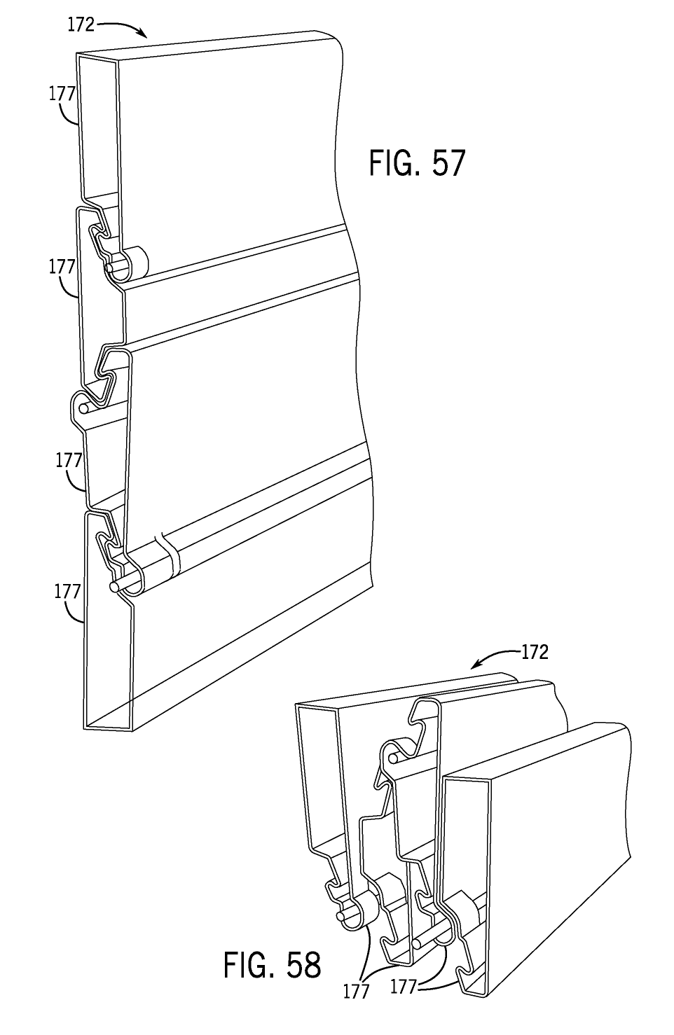

To manage drafts in the winter, the tier 1 base 170 can have a twin sheeted skirt 172 made of four panels 177, each similar to a plastic 2×6 (FIGS. 55-58), but molded with hinge knuckles and interconnecting hinge rods that allow the panels 177 to be accordion folded (FIGS. 56 and 58) which allows them to be retracted in the summer or unfolded and locked in place (FIGS. 55 and 57) in the winter. On the tier 2 base 180, the skirts 190 will be constructed of thick rubber conveyor belt material (e.g., FIG. 48). The rubber skirts 190 are removable in the summer to provide for the desired ventilation and to that end may be provided with a keyhole or other easily removable connection to the base. In the cooler months, the rubber skirts are installed to eliminate drafts from the underside of the hutch.

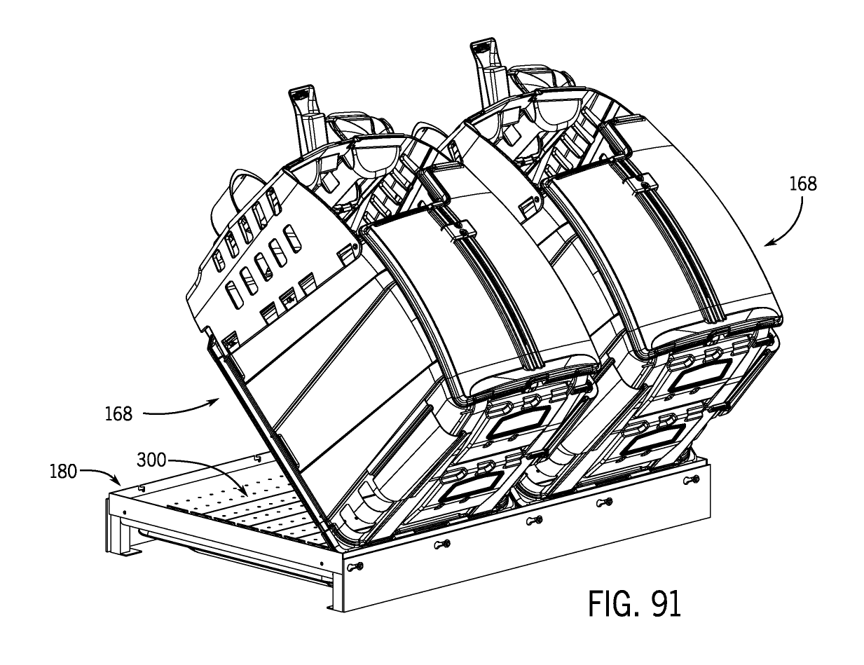

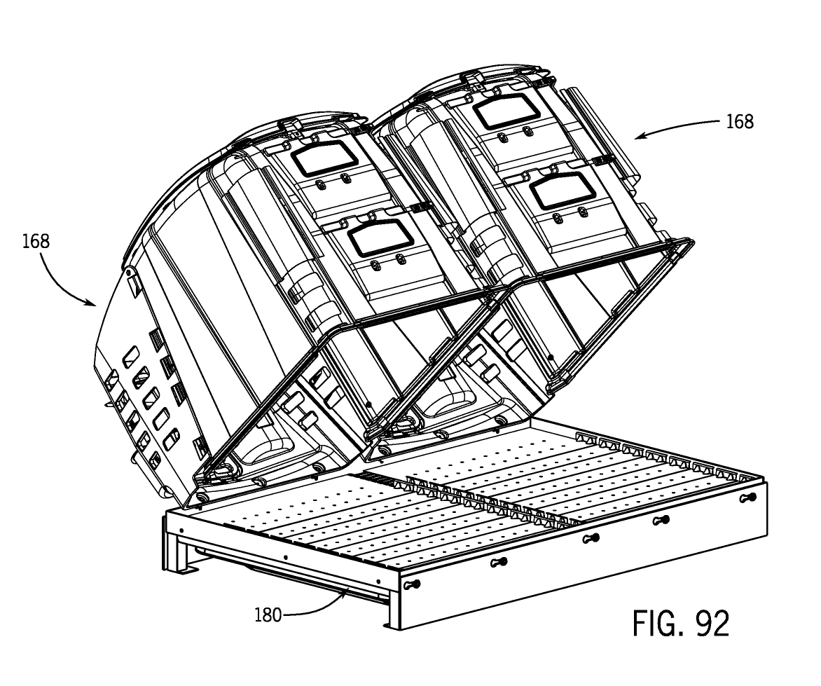

The top of the plastic skirt 172 on the tier 1 base 170 or the steel base in the tier 2 base 180 can be provided with one or more hinge knuckles that mate with hinge knuckles of the housing unit in the front and back (FIGS. 91 and 92). This provides hutch tie-downs, but also facilitates easy clean-up maintenance of the inside of the unit by pivoting the unit up about either the front or rear hinge axis provided by these knuckles.

On the tier 1 base, the flooring can rest on an angle section mounted (e.g., welded) inside or on the 2-½″ piping. The ribs of the steel support grate 204 can be under the rungs of the flooring 196 to eliminate potential waste catchers. In some applications, the floor grates 196 can sit on top of the piping structure, support grate(s) 204 can be provided under the floor tile(s) 196 or other appropriate support provided if needed.

Either base can be mounted over a California wash alley (a concrete canal under the row of hutches that catches waste from the hutches and can be flushed out), and the skirting can be used in the same way to eliminate drafts or maximize ventilation.

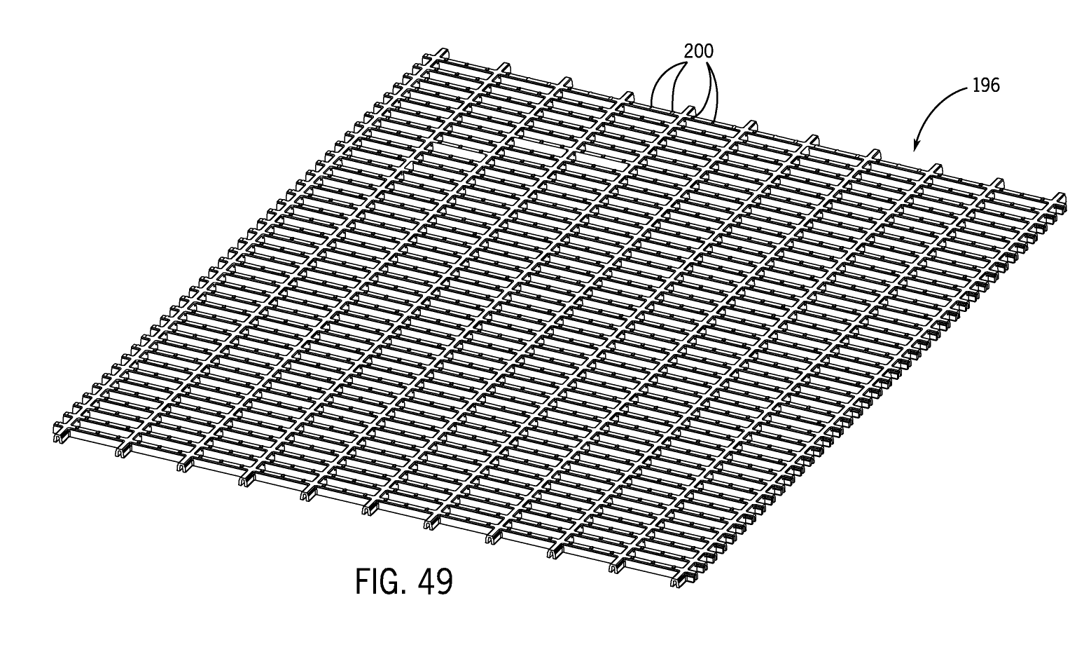

Beneficial ventilation is provided to the calf if it comes from underneath and flows over the animal, especially in the hot summer months of August and September. Having the base always elevated enables ready ventilation by folding up the base skirting panels 177 or removing the skirt 190. Molded plastic floor grating 196 (FIG. 49) can have a ⅞″×4″ opening to maximize the open area for ventilation and to minimize catching of waste. In the disclosed embodiment, the open area of the grate 196 is 47.6%. Having this as high as possible is important to calf health, as it minimizes waste in contact with the calf and maximizes ventilation. The preferred range for the open area of the grate 196 is 44-52%, with 47-49% more preferred.

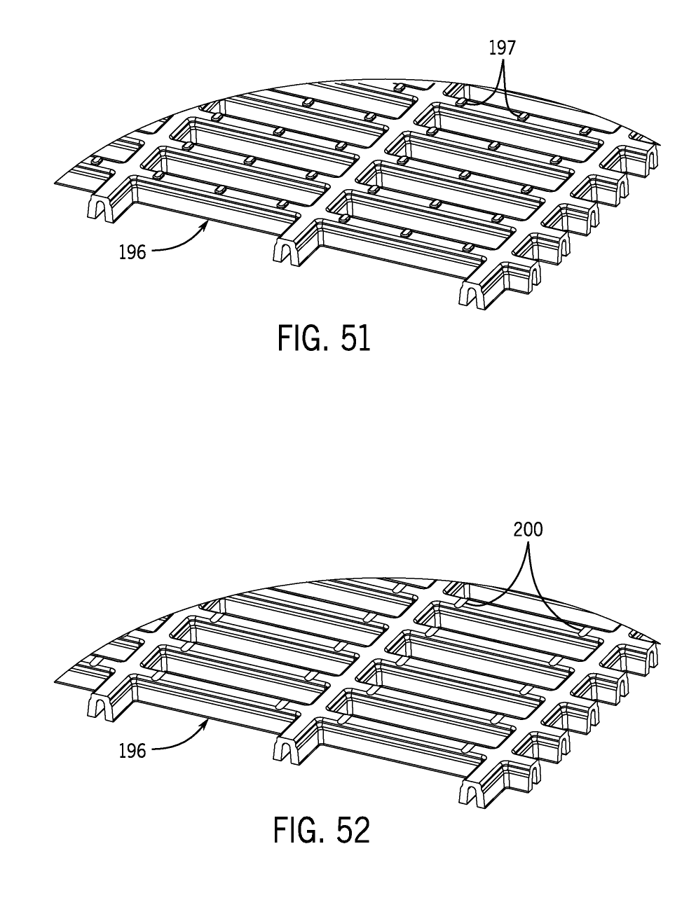

The floor tile grate 196 preferably has projections or nubs 197 (FIG. 51) or scallop divots 200 (FIG. 52) in the top of the grating to provide footholds for the calves. The projections may be, for example, 0.06″ tall. It is preferred that their height be in the range of 0.015″-0.25″. The rungs of the grate 196 are of the same height where they are joined together at the intersections of the rungs to define the grid of open areas, and tops of the rungs are at the same height so an upper surface of the grate is flat except for any recesses or projections provided in the top of the grate 196. Thereby the molded grate 196 provides a flat upper surface to eliminate pressure points for the lying calves and to give the calf a flat surface to stand on.

The floor tile grate 196 can be single sheet or twin sheet thermoformed PVC or HDPE using a compression molding approach. If twin sheet thermoformed, the top plastic sheets used to mold the floor tiles 196 may have a thermoplastic elastomer (TPE) top layer to further provide a softer and non-slip surface for the calf. Such sheets may be made by a co-extrusion process. The top sheet from which the floor tile 196 is molded may have a total thickness of 0.156″ for example, with the top 0.03″ of that sheet being the TPE layer and the lower 0.126″ being the structural plastic like PVC or HDPE. The bottom sheet (e.g., PVC or HDPE) of the twin sheet structure may have a thickness of 0.300″ to give the molded composite floor tile 196 a thickness of 0.62″, for example, which is thicker than 0.300″+0.156″ since each leg of the grid is formed in an arc cross-section (FIGS. 51 and 52). In the embodiment in which projections 197 are provided, they may be, for example, 0.06″ tall, to provide an overall floor thickness of 0.68″ (0.62″+0.06″), for example. The floor can typically be sized as 4′×5′. Two panels will fill one base. The panels can also be cut to accommodate 6′ deep systems.

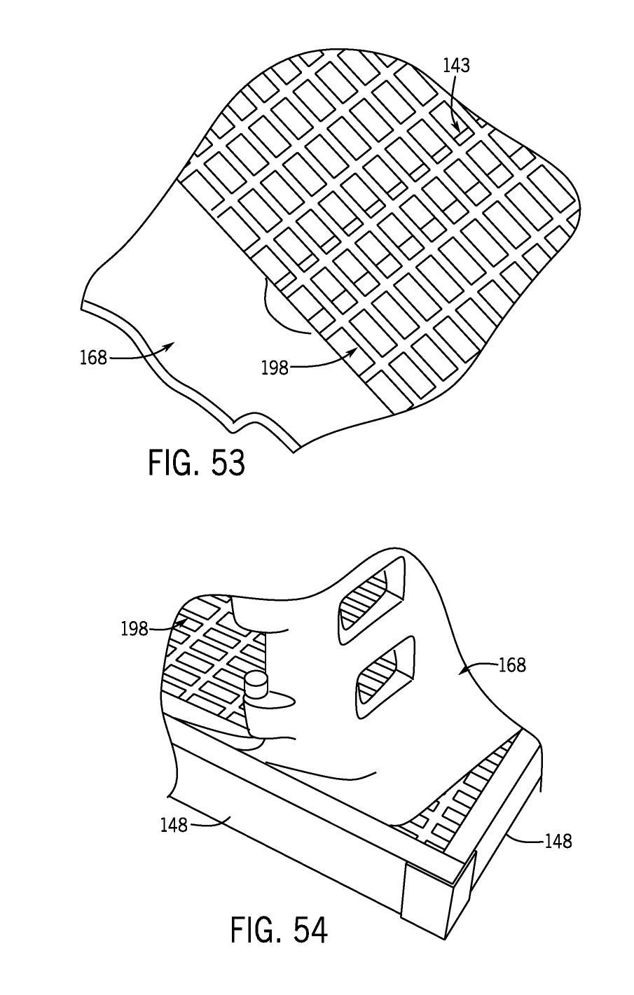

FIGS. 53 and 54 illustrate how a prior art floor grate 198 may be supported on a welded steel base. Such grates are typically a grid of steel rods woven and welded together and coated with rubber. They are strong enough by themselves that no additional support grate like the grate 204 is needed, but do not provide a generally flat upper surface since there are peaks at each intersection of the woven rods.

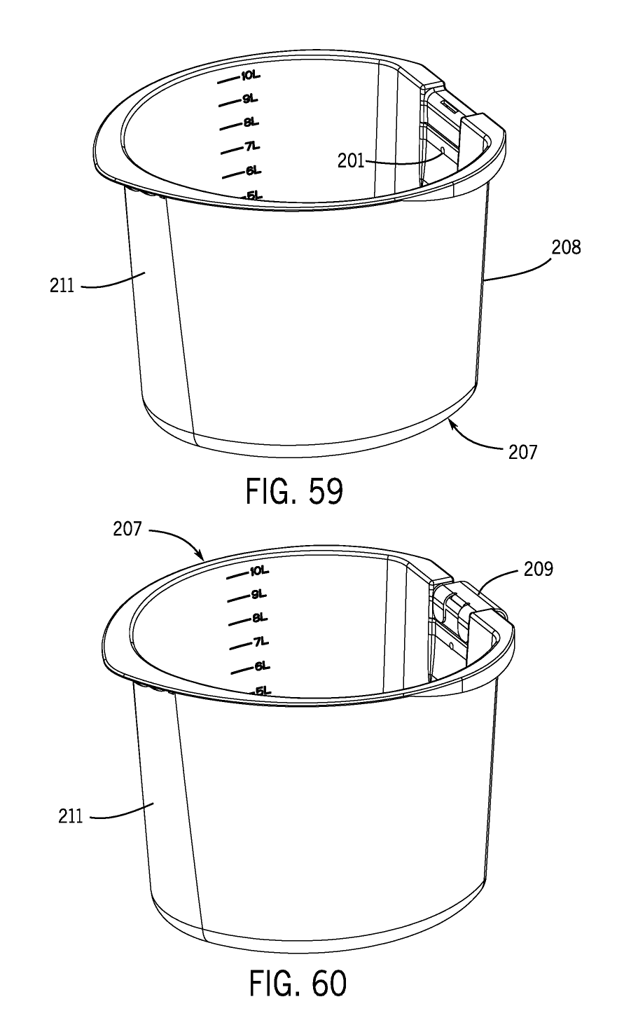

A bucket 207 (FIGS. 59-69) can work on multiple systems via an interchangeable attachment clip 209. The bucket has a generally flat rear outer surface 208 and a generally circular front surface 211. The clip 209 attaches to the top rear of the bucket as described below.

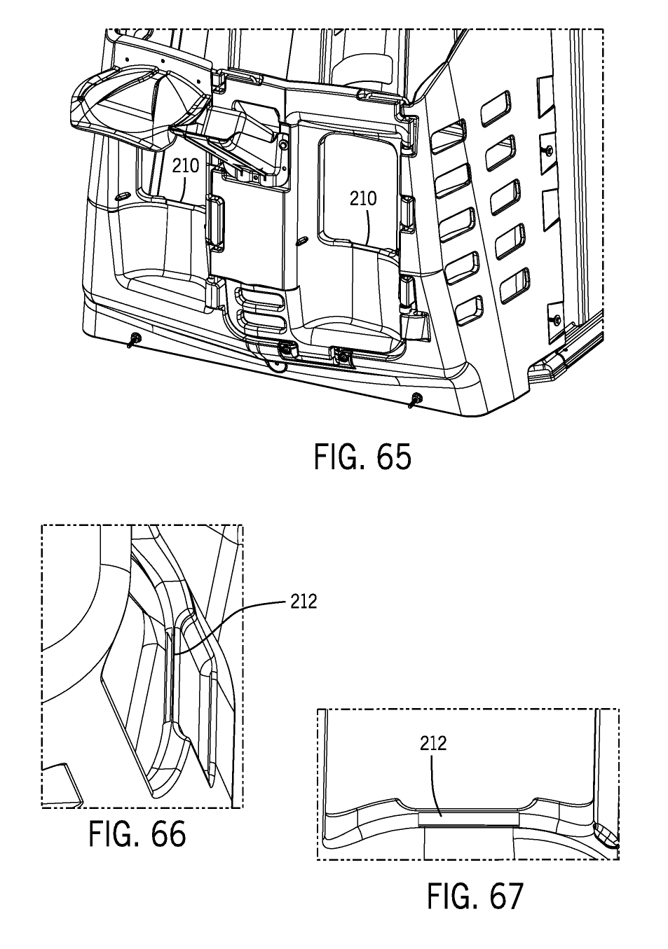

To improve attachment of the bucket in each bucket holder receptacle at the front of the unit, the top edge of the rear wall defining the receptacle recess has a slot 210 (FIG. 65) with an upstanding backstop wall 212 (FIG. 66). The wall 212 gives the bucket clip tongue 216 (FIG. 62) a backstop to help the user find the slot location when inserting the tongue 216 into the slot 210. The clip 209 can be bolted, screwed, or otherwise secured to the bucket 207 using an appropriate fastener through the holes 201, 203 in the bucket and clip and has fingers 213 (FIG. 69) that hook over the top of the bucket to overlie the inside of the bucket. Hole 203 is formed in a leg 214 on the outside of the bucket and hook leg 215 of the clip 209 that is inserted in the slot 212 is outside of the leg 214. The clip 209 is therefore easily removable from the bucket 207 so it can be replaced if broken or if a clip of a different design, for example with a hook for hooking over an edge, rather than a leg for insertion into a slot, is desired to be used with the bucket.

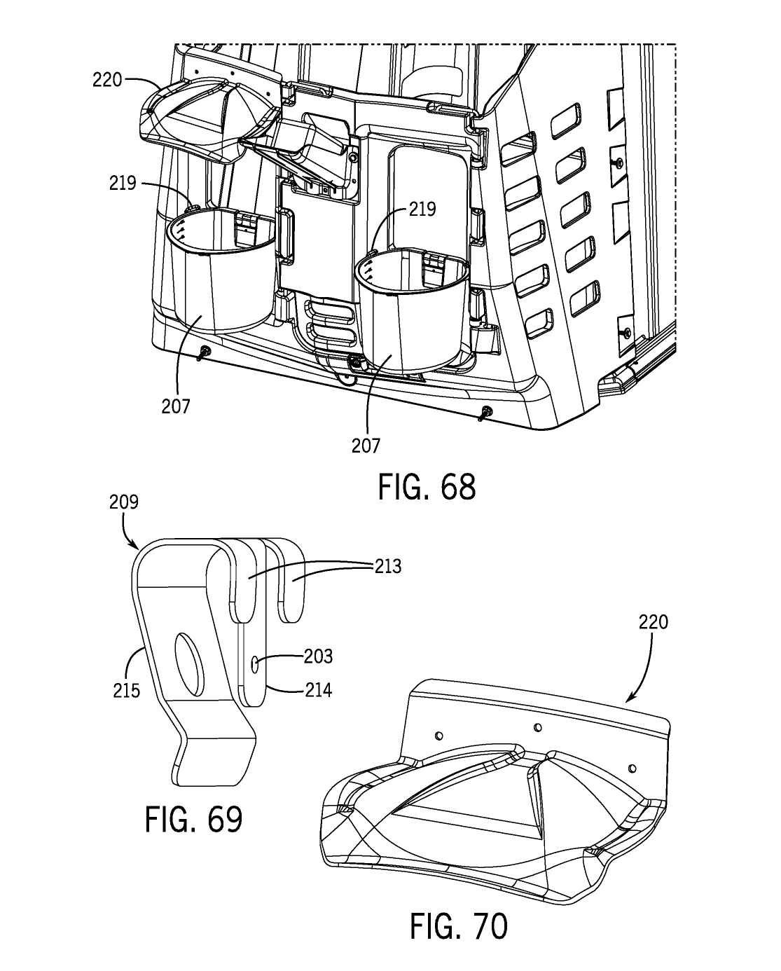

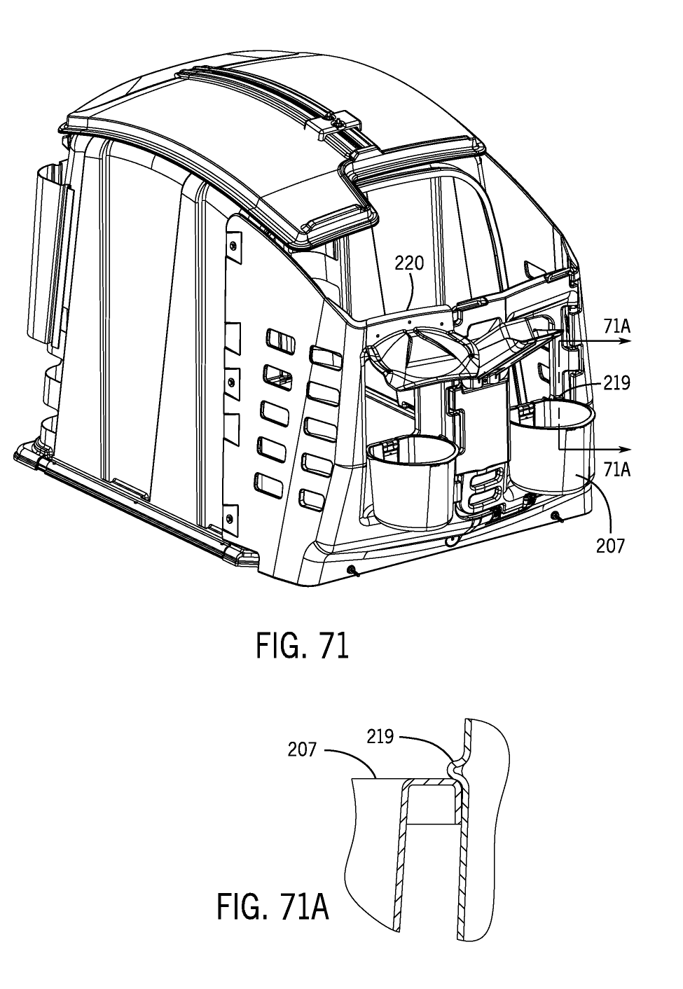

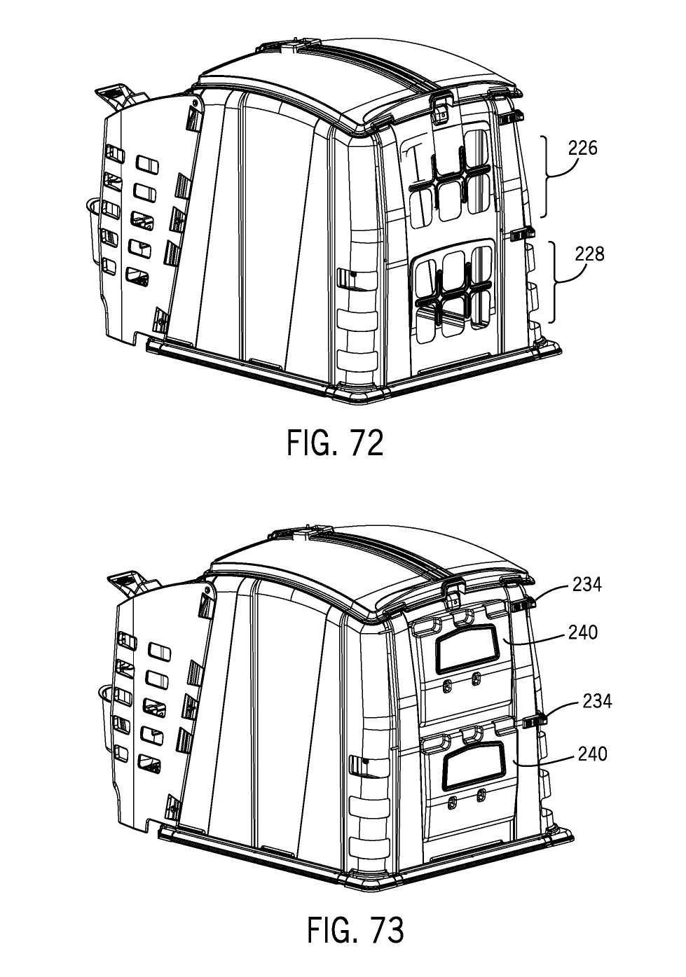

Small bump outs 219 (FIGS. 68 and 71A) are provided on the front of the housing unit that the top edge of the bucket 207 can snap under to help lock the bucket in, thereby reducing the chance that the bucket will be dislodged from the receptacle by the calf.

A rain visor 220 (FIGS. 70-71) can be bolted or otherwise suitably attached to the front of the unit, i.e., to the pen, above the feed bucket. The rain visor molded into the roof could then be eliminated. By doing this, rain protection to the feed bucket is provided even when the roof is open. The visor 220 could also be mounted to the door 20, over the right bucket.

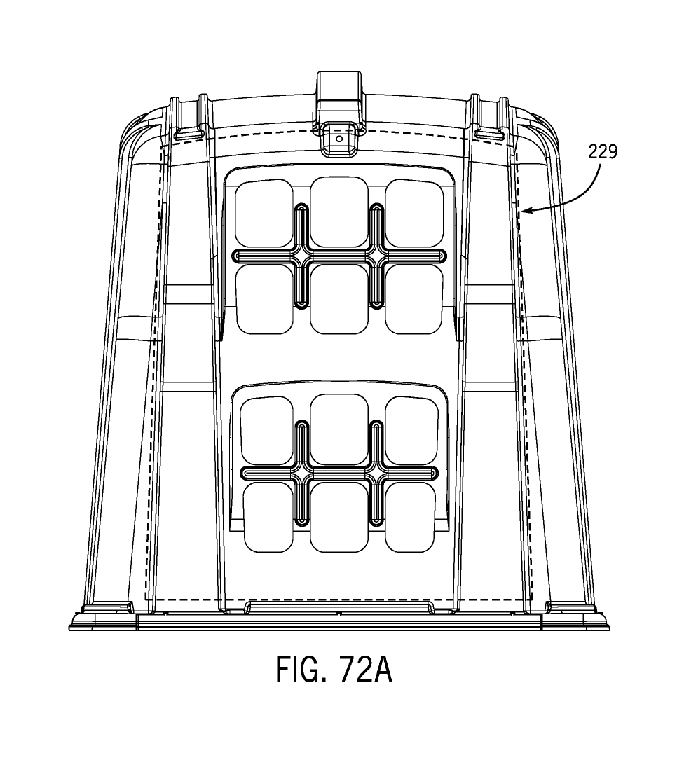

Referring to FIG. 72, the back wall of the hutch has additional ventilation openings with both upper and lower sets of ventilation openings 226 and 228. The benefit is to increase the amount of ventilation but also to lower the height of it in the unit so that it is closer to the calf if the calf is lying down. The amount of open area in the back of the unit is increased while at the same time adding strengthening ribs. In the disclosed embodiment, the total open area of the rear wall of the hutch is 29.1%, the rear wall area being measured in the horizontal direction to the outside of the radius of the vertical out-bump supports, i.e., to the beginning of the radius that defines the rear corner posts of the hutch. This total area is shown within dashed lines 229 in FIG. 72A. In the vertical direction, the area of the rear wall is measured to a projected point along the radius that joins the top of the hutch and the rear of the hutch, as shown in FIG. 72A. Thereby, the lower half of the rear wall has 29.1% open area, as does the upper half of the rear wall. Preferably, the range of open area in the rear wall is 10-60%, and particularly that is preferred in the lower half of the rear wall, and it is preferred that this open area be closable.

In addition, as shown in FIGS. 73-83, the hinge location of the window cover 240 is changed to the top from the bottom compared to the first embodiment. The additional ventilation will be able to be covered through the use of two covers 240 rather than one as in the first embodiment. With the hinge on the top, each cover 240 can serve as a sun shade and rain protection in addition to serving to close off or open the ventilation openings.

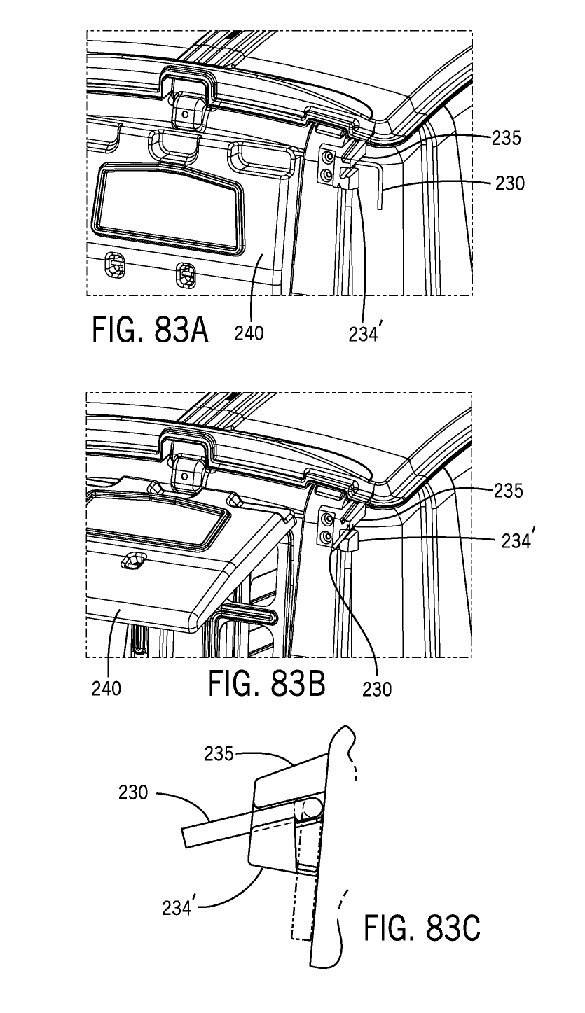

The hinge handle 230 (FIG. 77) is attached to the cover 240 so that the cover can be opened and held open without any negative interaction from the calf inside, for example the calf being able to bump it closed. The handle 230 provides a hinge pin between the cover 240 and the hutch, is secured to the inside surface of the cover 240 so as to be slideable along the hinge axis 232, so the handle end 246 can be supported on the support block 234 to hold the cover 240 open as shown in FIG. 83.

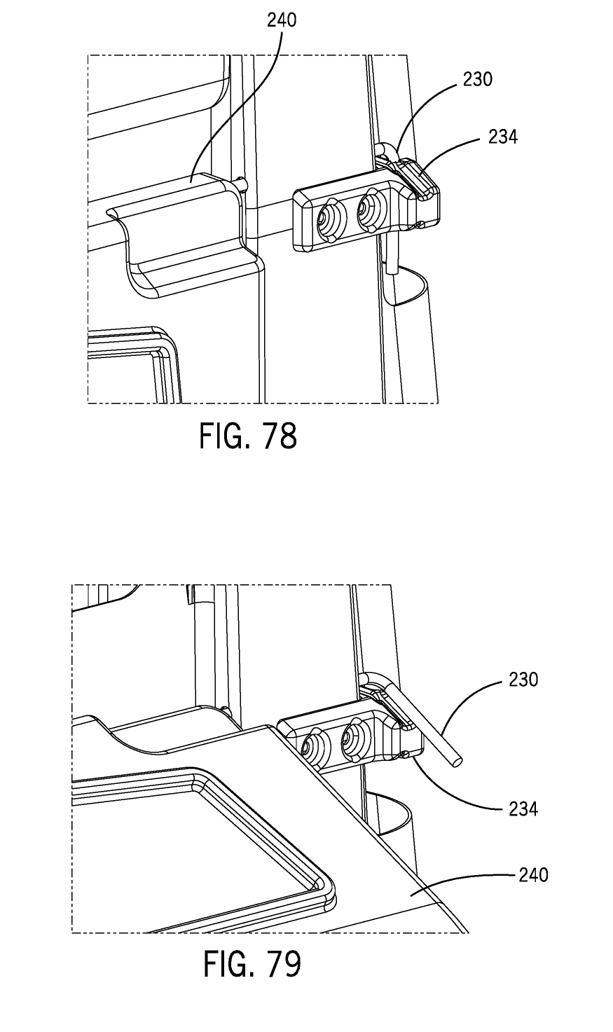

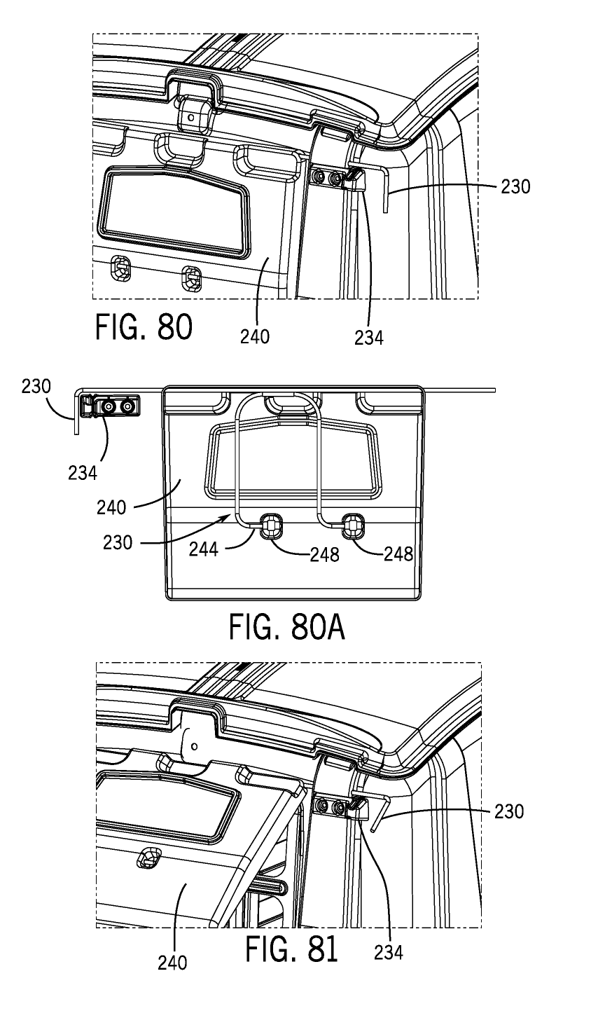

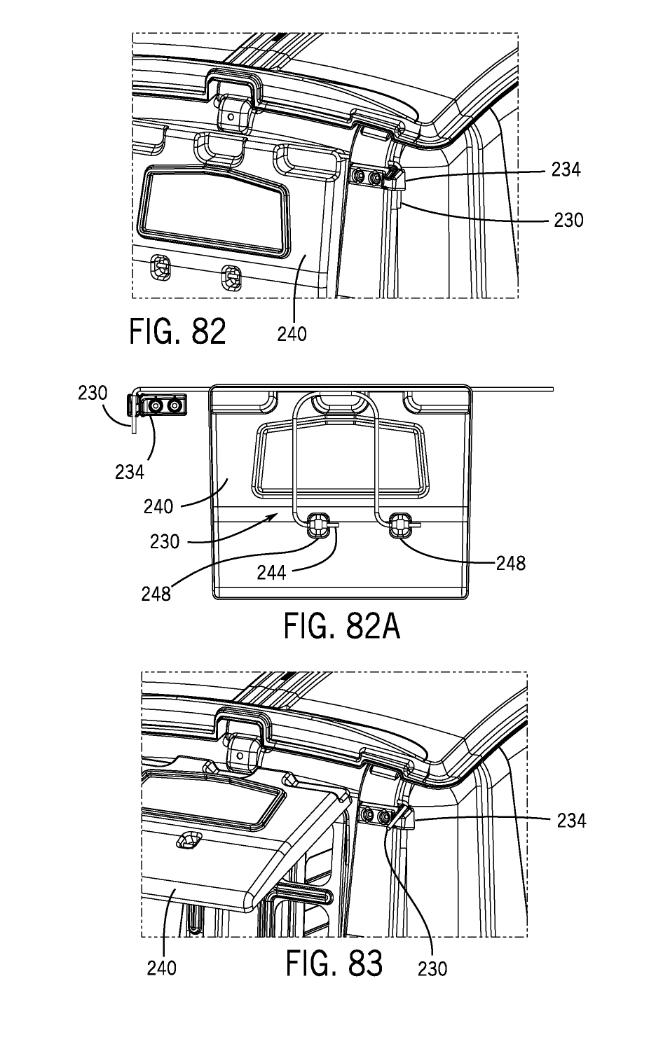

When the handle end 246 of the hinge handle 230 is slid in front of the support block 234 (FIG. 78), between the block 234 and the rear wall of the hutch, the hinge handle 230 holds the cover closed and prevents the cover 240 from being blown open or nudged open by a calf (FIG. 82). The hinge handle 230 (FIG. 77) has ends 244 of bent legs 245 that extend downwardly from and are welded to the hinge pin part 247 of the handle 230. The ends 244 can be inserted into holes formed in the side walls of structures 248 (FIG. 80A) upstanding on the inside surface of the cover 240 so that the handle 230 and the cover 240 rotate together about the hinge axis 232, defined by the hinge pin part 247 of the hinge handle 230.

FIGS. 83A-C illustrate an alternative support block 234′ which is molded to have an open limiting structure 235 spaced above the ledge on which the handle 230 is supported in the open position of the cover 240. The limiting structure 235 prevents the cover 240 from opening to an excessively open position when the handle portion of the hinge handle is supported by the block in the open position. This prevents the cover 240 from being blown too much further open by the wind and limits flapping of the cover in the wind when the cover is in the open position.

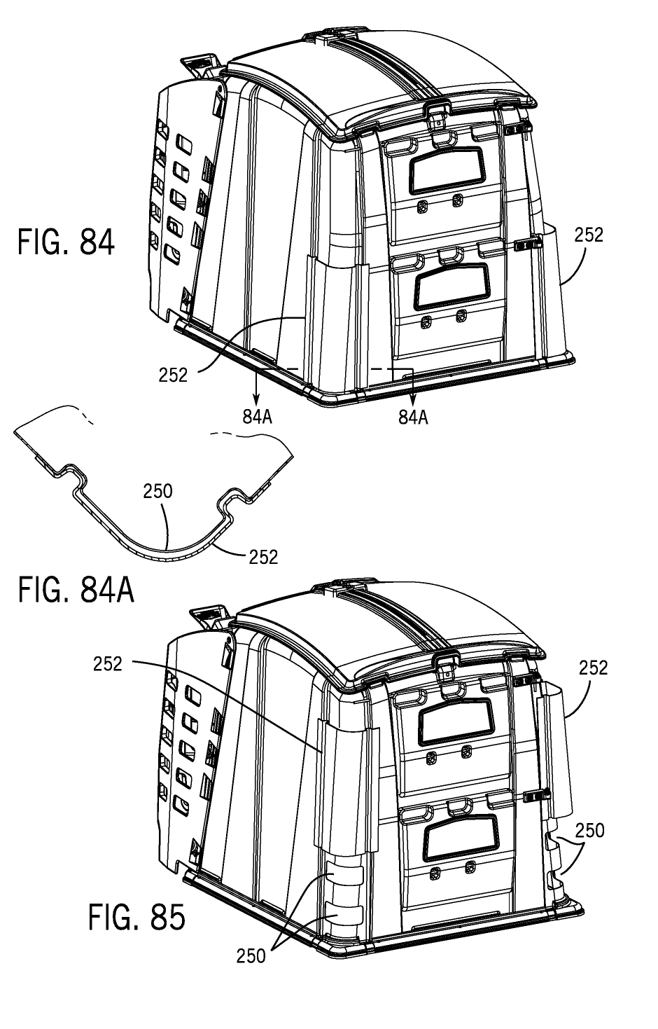

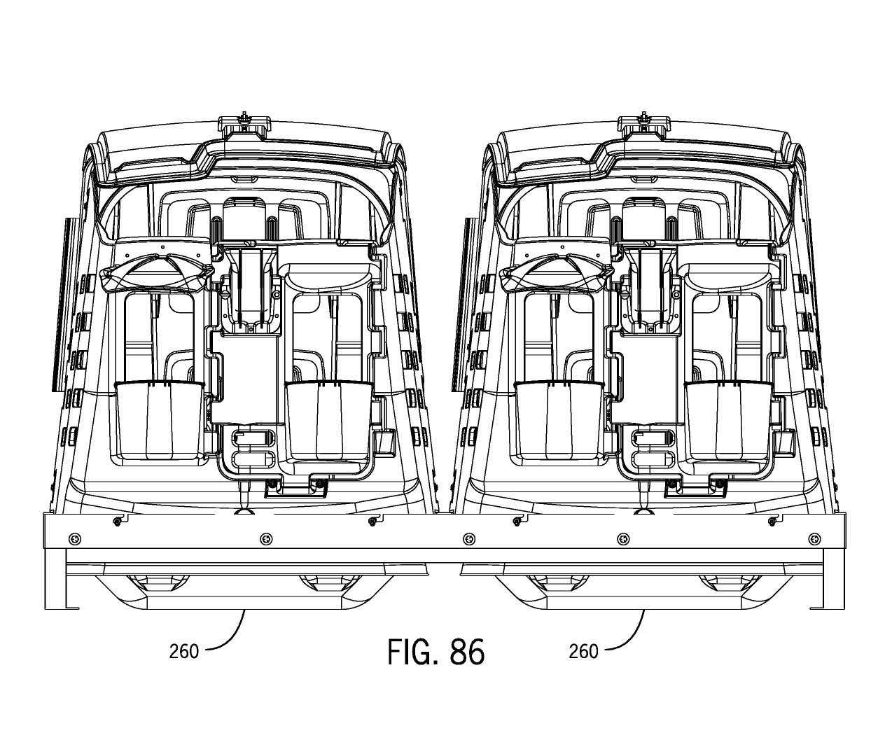

For additional ventilation, the hutch can have openings 250 (FIG. 85) in one or both of the rear corner posts (rear corners) in the lower half of the unit to increase flow across the animal. The corner structure (FIG. 84A) of the hutch can be used as a means in that area to serve as a way to provide a sliding closure 252 while avoiding issues associated with manure build-up on moving mechanisms. This could be an accessory, and could be retrofitted to existing hutches. The closure 252 could be held in the open position by a suitable pin through the closure and hutch or other mechanism. In the disclosed embodiment, the lower half of the rear corner posts has an open area of 85%, with the total area being the area of the radius that defines the corner. This open area is preferably in the range of 30-100%.

To improve sanitation, a catch pan 260 (FIGS. 86-88) can be provided under each hutch, under the base, that allows waste to be managed on a timely cycle. The catch pan can be mounted under the base similar to a cabinet drawer, or lay on the ground. The catch pan can be accessed with the base skirting in an up or removed position. The pan can be dumped manually or mechanically, similar to how garbage cans are handled by the city, lifted by a fork-type vehicle and tipped forwardly into a receptacle. The activity of emptying pans requires labor, but at the same time eliminates the need to relocate hutches, clean up the waste, and rebuild hutches, and reduces the labor required to tend to a healthy calf. This system can be used in winter and summer and can be provided as an accessory.

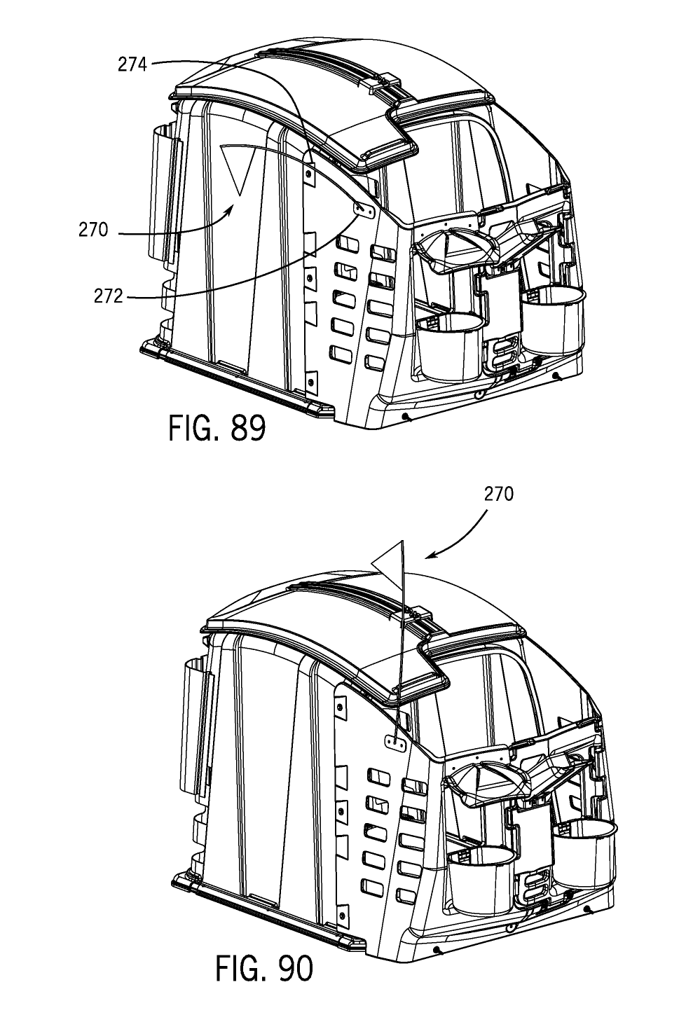

Referring to FIGS. 89 and 90, a treatment flag 270 can be provided to give a visual cue to calf care-givers that special attention is required to a specific calf. When a worker suspects a health issue with a certain calf, the flag can be raised (FIG. 90) and the vet can then focus on raised flags. This flag and pole could be something similar to a bike flag, and have one mount 272 on the housing unit to hold it upright and another mount 274 on the unit under which the flag can be hooked to hold the flag down.

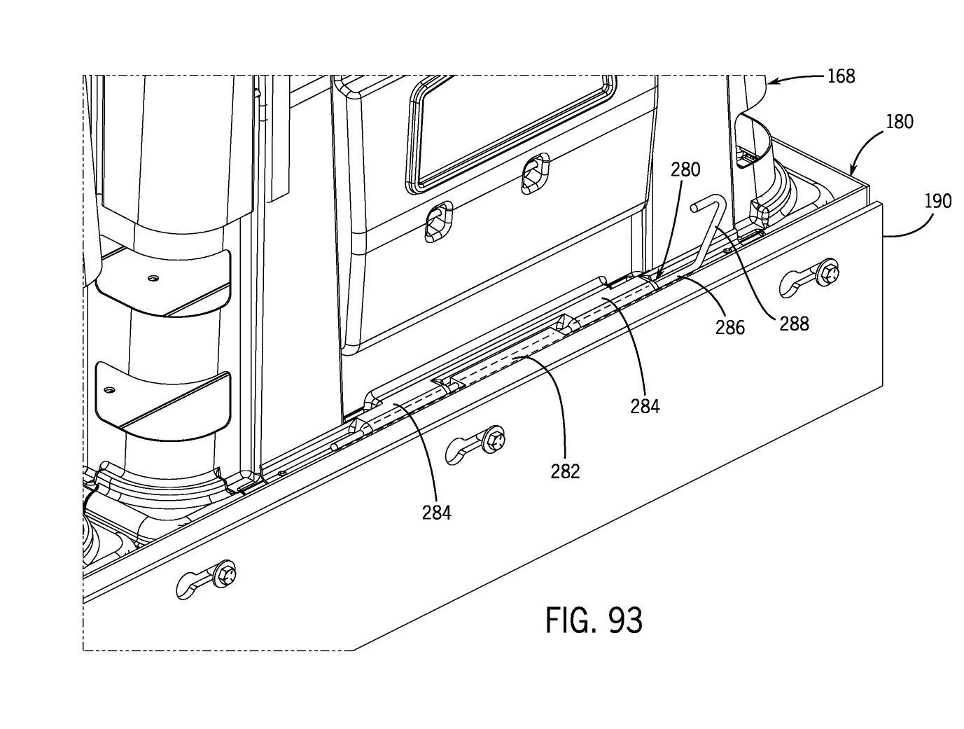

Referring to FIGS. 91-93, as mentioned above, pinned hinges 280 can be provided on the front and back of the housing unit 168 with central hinge knuckle 282 provided as part of the top skirt panel 177 of the base 170 or, as illustrated in FIG. 93, provided directly on the base 180. Knuckle 282 is between knuckles 284 which are plastic molded as part of the housing unit, at either the rear lower edge or at the front lower edge of the housing unit. A removable hinge pin 286 with handle 288 at one end extends through the knuckles 282 and 284 to create a hinge axis. The hutch is held down in a robust manner and the hinge pin can be easily pulled for cleaning.

The procedure for cleaning out the housing units 168 provided with unit hinging could be as follows. First, the hinge pins are pulled out and pushes the housing units are pushed into the up position and propped up. Any bedding is then removed, the unit is hosed or scrubbed out and any new bedding may be placed in the unit when propped up or after the unit is lowered. The units are then lowered and re-pinned. The units can be cleaned from either end because the hinges can be provided on both the front and rear ends.

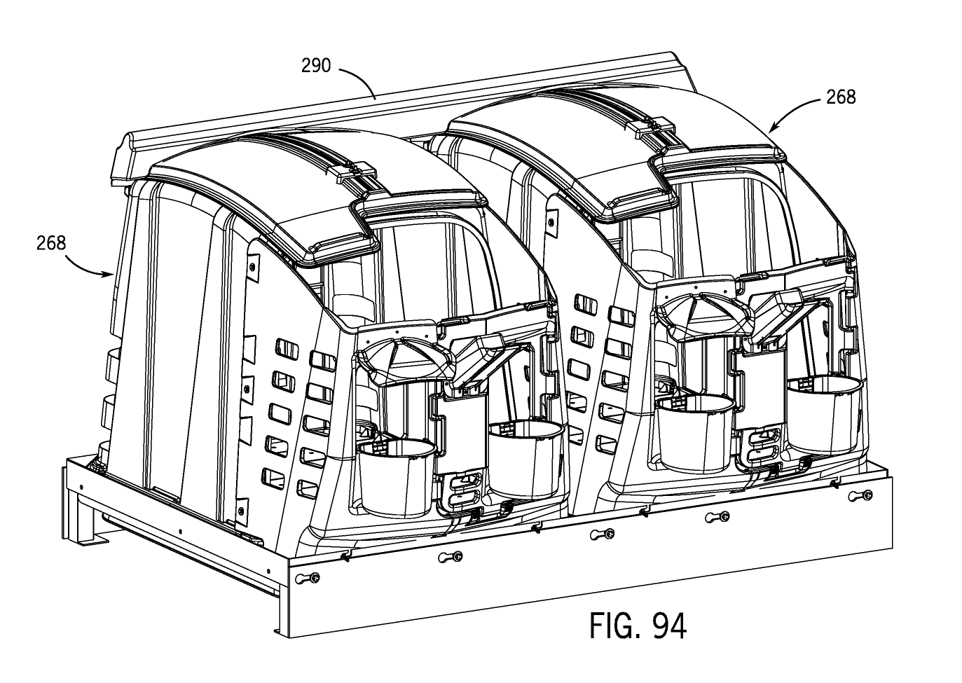

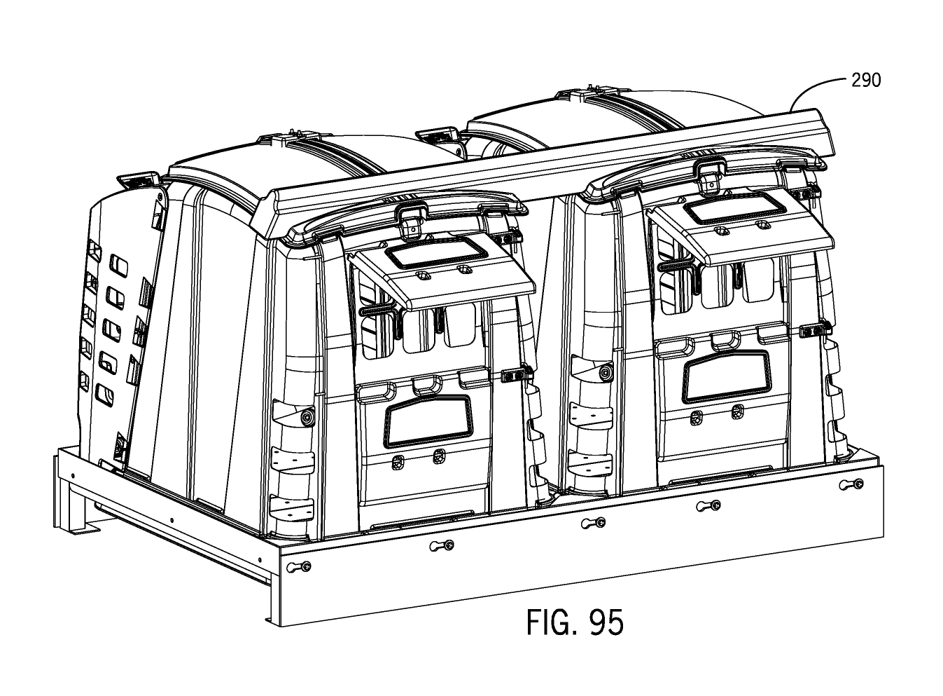

Referring to FIGS. 94-95, a multi-roof bar 290 is attached to two or more roofs of adjacent housing units 168 (FIG. 94-95) by bolting, screwing or other appropriate means so that the roofs can be opened or closed together, with a single movement. A single bar is shown at the rear in FIGS. 94-95, but another bar could be added at the front, or a single bar could be provided at the front. By tying the roofs together with bars 290 in the front and the rear, more units can be operated simultaneously, for example, 3 or 4 could be tied together and the roofs moved simultaneously between extended and retracted positions. A twin sheet plastic thermoformed structure can be used to make the bar 290 and the bar can be provided as an accessory.

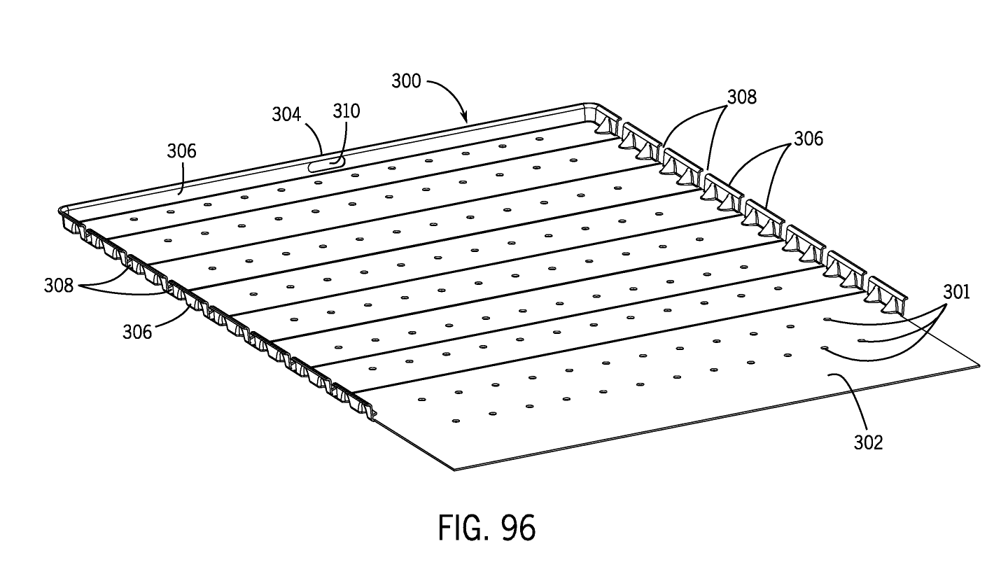

Although the floor grate 196 does not require bedding (typically straw), some ranchers will still want to use bedding, especially in the colder months. Bedding can be placed on the floor grate 196, which allows some waste to be separated away from the calves while providing warmth from the bedding. When that is done, cleaning is facilitated by using a bedding tray 300 (FIGS. 96-98) that creates a structure that can be rolled from one end. The tray 300 has perforations 301 in it so that waste can flow through the grate.

One end 302 of the tray 300 attaches to the floor grate 196, with screws, bolts or other appropriate fasteners. This end preferably has no side walls 306 that would obstruct the removal of used bedding on top of the tray 300. The opposite end 304 may have a sidewall 306 and the sides may have sidewalls 306, albeit with openings 308 between them so the tray can be rolled toward end 302. The other end 304 is grabbed with a hook through the aperture 310 and pulled across the hutch rolling toward end 302 upside down so that the used bedding on the tray is emptied into the cart aisle beyond end 302. The bedding and waste can then be scraped up as is currently done.

Preferred embodiments of the invention have been described in considerable detail. Many modifications and variations to the preferred embodiments described will be apparent to a person of ordinary skill in the art. For example, it may be possible to use a different sliding mechanism that would eliminate the slot 88 that extends through the sliding portion 24, which does allow a small amount of rain through. Additionally, it may be possible to hinge or slide the movable part of the roof such that it also serves the function of the front door. Therefore, the invention should not be limited to the embodiments described.

We claim:

1. An animal housing unit comprising:
a hutch enclosing a living space shelter with opposite spaced apart side walls, a rear wall, and a roof, and having an open front, the side walls, rear wall and roof being integrally connected in one monolithic piece;
a separate pen at the front of the hutch, the pen having opposite side walls, a front wall connected to the side walls at the front of the side walls and having an open top, the side walls of the pen being connected to the hutch so as to enclose the front of the hutch on the sides and front; and
a movable roof mounted on and supported by the hutch that can be moved to an open position in which the pen is not covered or to a closed position in which the pen is at least partially covered by the movable roof.

2. An animal housing unit as in claim 1, wherein the roof of the hutch and the movable roof are curved.

3. An animal housing unit as in claim 2, wherein said roofs are both curved so that they form an arc about at least two axes.

4. An animal housing unit as in claim 1, wherein the roof of the hutch and the movable roof fully close the top of the animal housing unit when the movable roof is fully extended.

5. An animal housing unit as in claim 1, wherein the roof is attached to the roof of the hutch and is slideable between the open and closed positions, further comprising guiding structures in at least one of the movable roof and the roof of the hutch that guide said movable roof as it slides.

6. An animal housing unit as in claim 1, wherein the roof is double walled with the walls fused together at the outer perimeter of the roof and other interior areas of the roof and with air spaces between the walls in areas where they are spaced apart.

7. An animal housing unit as in claim 1, further comprising an extension of the movable roof at a front edge of the roof, the extension extending past the front of the pen over a bucket position to shield a feed bucket that could be placed at the bucket position.

8. An animal housing unit as in claim 1, further comprising an access door positioned in the front of the pen that can be opened or latched closed.

9. An animal housing unit as in claim 1, wherein the pen tapers so that it is narrower in front than it is in the back of the pen.

10. An animal housing unit as in claim 1, wherein the pen is hinged to the hutch so that the front of the pen can be pivoted in an upward direction relative to the hutch.

11. An animal housing unit as in claim 9, wherein the front of the pen tapers so that it narrows in width in an upward direction.

12. An animal housing unit as in claim 1, further comprising a composite base having steel members at least partially enclosed by plastic panels that position the housing unit.

13. An animal housing unit as in claim 1, further comprising flooring tiles and wherein said composite base positions said flooring tiles between the composite base and the interior of the housing unit, wherein said floor tiles have openings through them through which materials from above can drop.

14. An animal housing unit as in claim 13, wherein the flooring tiles have an open area in the range of 44-52%.

15. An animal housing unit as in claim 14, wherein the open area of the flooring tiles is 47-49%.

16. An animal housing unit as in claim 1, wherein a floor of a housing unit comprises multiple flooring tiles supported on a base that supports the housing unit.

17. An animal housing unit as in claim 1, further comprising a bottle holder having a front end and a mounting end, wherein the front end is wider than the mounting end, and wherein the mounting end is connected to the front of the pen.

18. An animal housing unit as in claim 1, further comprising a slideable roof mounted on and supported by the hutch that can be moved to an open position in which the pen is not covered or to a closed position in which the pen is at least partially covered by the slideable roof, and wherein said sliding roof is secured to the hutch at least partially by members that are molded into at least one of the hutch and the sliding roof.

19. An animal housing unit as in claim 1, further comprising at least one reinforcement member that sandwiches at least a portion of a lower edge of the hutch between two layers of material of the reinforcement and hides an end of a fastener that connects the edge and the reinforcement.

20. An animal housing unit as in claim 1, further comprising a base and a riser, the housing unit being supported on the base and the base being supported on the riser, wherein the riser telescopes with an outer guide member and an inner member telescopically arranged inside the outer member, wherein the outer guide member is attached to the base and is slotted part of the way up with a notch in the outer member offset from the slot; the inner member having at least one pin that rides in the slot so as to enable elevating the outer guide member relative to the inner member by rotating the two members relative to each other to engage or disengage the pin in the notch.

21. An animal housing unit as in claim 20, wherein the inner member further comprises a pin to keep the inner member from dropping out of the outer guide member.

22. An animal housing unit as in claim 1, wherein the housing unit is supported on a base unit that is elevated above the ground.

23. An animal housing unit as in claim 1, wherein two of said housing units are supported on a base unit that is elevated above the ground.

24. An animal housing unit as in claim 23, wherein the base unit is supported by risers that are adjustable in the height at which they support the base unit.

25. An animal housing unit as in claim 1, further comprising rain gutters formed in the hutch that channel rain water away from intrusion to the interior of the hutch.

26. An animal housing unit as in claim 1, wherein the front wall of the pen extends outwardly beyond a lower edge of the front of the pen that is below where the front of the pen extends outwardly.

27. An animal housing unit as in claim 26, wherein the front wall of the pen is double walled.

28. An animal housing unit as in claim 1, wherein multiple hutches when disassembled from the pens are stackable and nestable.

29. An animal housing unit as in claim 1, wherein multiple pens when disassembled from the hutches are stackable and nestable.

30. An animal housing unit as claimed in claim 1, further comprising a base under the unit supporting the unit above the ground, the base having ground engaging legs that space the base a distance above the ground.

31. An animal housing unit as claimed in claim 30, wherein a skirt is provided that closes off a space beneath the base at least at front and rear sides of the base.

32. An animal housing unit as claimed in claim 31, wherein the skirt is fixed to the base.

33. An animal housing unit as claimed in claim 32, wherein the skirt is an elastomeric strip.

34. An animal housing unit as claimed in claim 32, wherein the skirt is openable and closable.

35. An animal housing unit as claimed in claim 34, wherein the skirt is accordion foldable and unfoldable into the open and closed positions.

36. An animal housing unit as claimed in claim 30, wherein the skirt is removable.

37. An animal housing unit as claimed in claim 30, wherein each base supports two units and two bases can be secured together end to end so that the two secured bases supporting four housing units can be lifted with a single forklift truck.

38. An animal housing unit as claimed in claim 30, further comprising a plastic molded floor having openings therein, the floor being positioned as the floor of the housing unit above the base, said floor being supported by a steel grate that is underneath the plastic floor.

39. An animal housing unit as claimed in claim 38, wherein the floor has an open area in the range of 44-52% of the total area of the floor.

40. An animal housing unit as claimed in claim 1, further comprising a bucket attached to the unit by a clip.

41. An animal housing unit as claimed in claim 40, wherein the clip is removable from the bucket.

42. An animal housing unit as claimed in claim 41, wherein the clip is attached to the bucket by a removable fastener.

43. An animal housing unit as claimed in claim 40, wherein a tongue of the clip is adapted to be inserted into a slot in a wall of a bucket receiving receptacle of the animal housing unit.

44. An animal housing unit as claimed in claim 43, wherein the slot has an upstanding rear edge that helps guide the clip into the slot.

45. An animal housing unit as claimed in claim 43, wherein the bucket receiving receptacle has a bump-out under which an upper edge of the bucket fits so as to help lock the bucket in place.

46. An animal housing unit as claimed in claim 1, wherein a front wall of the housing unit has a bucket receptacle and further comprising a rain visor extending from the front wall over the bucket receptacle.

47. An animal housing unit as claimed in claim 46, wherein the rain visor is attached to the front wall of the unit with fasteners.

48. An animal housing unit as claimed in claim 1, wherein a rear wall of the hutch has ventilation openings in the lower half of the rear wall.

49. An animal housing unit as claimed in claim 48, wherein the ventilation openings provide an open area of 10-60% of the lower half of the rear wall.

50. An animal housing unit as claimed in claim 49, wherein the ventilation openings provide an open area of 29-30% of the lower half of the rear wall.

51. An animal housing unit as claimed in claim 1, wherein ventilation openings are provided in the upper half and in the lower half of the rear wall of the hutch, with said openings providing an open are of 10-60% in each of the upper half and the lower half of the rear wall.

52. An animal housing unit as claimed in claim 1, including ventilation openings in a rear wall of the hutch and including a cover hinged to the hutch so as to be closeable over the ventilation openings, wherein the cover is hinged at an upper edge of the cover so as to be openable to act as a sunshade and rain block with the cover open.

53. An animal housing unit as claimed in claim 52, wherein the hinge of the cover includes a handle hinge attached to the cover so that the handle hinge can be locked in a closed position of the cover or propped open by a handle portion of the handle hinge being blocked by a block that is secured to the rear wall of the hutch.

54. An animal housing unit as claimed in claim 53, wherein the handle portion is blocked from opening to an excessively open position when the handle portion is supported by the block in the open position.

55. An animal housing unit as claimed in claim 1, comprising a closed top hutch and an open top pen at a front of the hutch, wherein there is at least one ventilation opening in at least one rear corner of the hutch at a position which is in the lower half of the hutch.

56. An animal housing unit as claimed in claim 55, wherein a cover fits on the corner of the hutch so as to slide up and down on the corner to either open or close the ventilation opening.

57. An animal housing unit as claimed in claim 55, wherein the at least one ventilation opening provides an open area of 30-100% of the corner area in the lower half of the corner.

58. An animal housing unit as claimed in claim 57, wherein the open area of the lower half of the corner area is approximately 85%.

59. An animal housing unit as claimed in claim 1, further comprising a manure catch pan and a base supporting the animal housing unit, the manure catch pan being positioned below the base so as to collect droppings from the housing unit above, the catch pan being removable from under the base so as to be emptied.

60. An animal housing unit as claimed in claim 1, further comprising a treatment flag attached to the unit which can be placed in either an up or down position.

61. An animal housing unit as claimed in claim 1, further comprising a tie-down hinge at at least one of the front and rear edges of the unit having a removable hinge pin, the hinge being operable to permit pivoting the housing unit relative to a base so as to tip up the end of the housing unit opposite from the hinge to facilitate cleaning out the housing unit.

62. An animal housing unit as claimed in claim 61, wherein said tie-down hinges are at both the front and the rear of the housing unit.

63. An animal housing unit as claimed in claim 1, comprising two or more animal housing units as claimed in claim 1, and a bar that is attached to at least two roofs of said housing unit so as to slide said roofs together.

64. An animal housing unit as claimed in claim 63, further comprising a second said bar, with one of said bars attached at a front and the other bar attached at a rear of said roofs.

65. An animal housing unit as claimed in claim 1, further comprising a bedding tray that is sized and shaped to lie atop a floor of the unit and receive bedding material placed on the tray, the tray being partially or fully movable relative to the floor of the unit after the bedding material has been soiled so as to remove used bedding materials from the housing unit.

66. An animal housing unit as in claim 65, wherein the tray is rollable from one end so as to remove bedding material on top of the bedding tray by rolling one end of the tray above and toward the opposite end of the tray.

67. An animal housing unit as claimed in claim 65, wherein one end of the bedding tray is attached to the floor of the unit and the other end of the tray is rollable toward the attached end.

68. An animal housing unit as claimed in claim 65, wherein sides of the bedding tray have sidewalls that are separated by openings to create living hinges so the tray can be rolled.

69. An animal housing unit as claimed in claim 1, wherein a floor of the unit comprises one or more plastic tile grates each defining a grid of open areas.

70. An animal housing unit as claimed in claim 69, wherein each tile grate has a total open area in the range of 44-52% of the total area of the grate.

71. An animal housing unit as claimed in claim 69, wherein the floor tile grates are thermoformed.

72. An animal housing unit as claimed in claim 69, wherein each floor tile grate has recesses in an upper surface thereof.

73. An animal housing unit as claimed in claim 69, wherein each floor tile grate has projections in an upper surface thereof.

74. An animal housing unit as claimed in claim 69, wherein the grate is comprised of rungs joined together at intersections of the rungs to define the grid of open areas, and tops of the rungs are at the same height so an upper surface of the grate is flat except for any provided recesses or projections.

75. A floor structure as claimed in claim 73, wherein the projections are of a height within the range of 0.015-0.25 inches.

76. A floor structure as claimed in claim 69, wherein the floor tile has an elastomeric top layer.

77. An animal housing unit comprising:
a hutch enclosing a living space shelter with opposite spaced apart side walls, a rear wall, and a roof, and having an open front, the side walls, rear wall and roof being integrally connected in one monolithic piece; and
a separate pen at the front of the hutch, the pen having opposite side walls, a front wall connected to the side walls at the front of the side walls and having an open top, the side walls of the pen being connected to the hutch so as to enclose the front of the hutch on the sides and front;
wherein the front wall of the pen extends outwardly beyond a lower edge of the front of the pen that is below where the front of the pen extends outwardly.

78. An animal housing unit as in claim 77, wherein the front wall of the pen is double walled.

79. An animal housing unit as in claim 77, wherein the pen is narrower at the front than it is at the rear.

80. An animal housing unit as in claim 77, wherein the front of the pen is narrower at the top than it is at the bottom.

81. An animal housing unit as claimed in claim 77, further comprising a base under the unit supporting the unit above the ground, the base having ground engaging legs that space the base a distance above the ground.

82. An animal housing unit as claimed in claim 81, wherein a skirt is provided that closes off a space beneath the base at least at front and rear sides of the base.

83. An animal housing unit as claimed in claim 81, wherein each base supports two units and two bases can be secured together end to end so that the two secured bases supporting four housing units can be lifted with a single forklift truck.

84. An animal housing unit as claimed in claim 81, further comprising a plastic molded floor having openings therein, the floor being positioned as the floor of the housing unit above the base, said floor being supported by a steel grate that is underneath the plastic floor.

85. An animal housing unit comprising:
a hutch enclosing a living space shelter with opposite spaced apart side walls, a rear wall, and a roof, and having an open front, the side walls, rear wall and roof being integrally connected in one monolithic piece;
a separate pen at the front of the hutch, the pen having opposite side walls, a front wall connected to the side walls at the front of the side walls and having an open top, the side walls of the pen being connected to the hutch so as to enclose the front of the hutch on the sides and front; and
wherein the pen is hinged to the hutch so that the front of the pen can be pivoted in an upward direction relative to the hutch.

86. A feed or water bucket for an animal housing unit, wherein the bucket can be attached to the unit by a clip that is removable from the bucket.

87. An animal housing unit including a bucket as claimed in claim 86.

88. An animal housing unit as claimed in claim 87, wherein a tongue of the clip is adapted to be inserted into a slot in a wall of a bucket receiving receptacle of the animal housing unit.

89. An animal housing unit as claimed in claim 88, wherein the slot has an upstanding rear edge that helps guide the clip into the slot.

90. An animal housing unit as claimed in claim 88, wherein the bucket receiving receptacle has a bump-out under which an upper edge of the bucket fits so as to help lock the bucket in place.

91. An animal housing unit including a front wall having a bucket receptacle and further comprising a rain visor extending from the front wall over the bucket receptacle.

92. An animal housing unit as claimed in claim 88, wherein the rain visor is attached to the front wall of the unit with fasteners.

93. An animal housing unit comprising a closed top hutch and an open top pen at a front of the hutch, wherein a rear wall of the hutch has at least one ventilation opening in the lower half of the rear wall.

94. An animal housing unit as claimed in claim 93, wherein the at least one ventilation opening provides open area in the lower half of the rear wall in the range of 10-60%

95. An animal housing unit as claimed in claim 93, including a cover hinged to the hutch so as to be closeable over the ventilation openings and wherein the cover is hinged at an upper edge of the cover, the hinge including a handle hinge attached to the cover so that the handle hinge can be locked in a closed position of the cover or propped open by a handle portion of the handle hinge being blocked by a block that is secured to the rear wall of the hutch.

96. An animal housing unit comprising a closed top hutch and an open top pen at a front of the hutch, wherein there is at least one ventilation opening in at least one rear corner of the hutch at a position which is in the lower half of the hutch.

97. An animal housing unit as claimed in claim 96, wherein the at least one ventilation opening provides open area in the range of 30-100% of the area of the lower half of the corner of the hutch.

98. An animal housing unit as claimed in claim 96, wherein a cover fits on the corner of the hutch so as to slide up and down on the corner to either open or close the ventilation opening.

99. An animal housing unit as claimed in claim 98, further comprising a manure catch pan and a base supporting the animal housing unit, the manure catch pan being positioned below the base so as to collect droppings from the housing unit above, the catch pan being removable from under the base so as to be emptied.

100. An animal housing unit comprising a closed top hutch and an open top pen at a front of the hutch, further comprising a treatment flag attached to the unit which can be placed in either an up or down position.

101. An animal housing unit comprising a closed top hutch and an open top pen at a front of the hutch, further comprising a tie-down hinge at at least one of the front and rear edges of the unit having a removable hinge pin, the hinge being operable to permit pivoting the housing unit relative to a base so as to tip up the end of the housing unit opposite from the hinge to facilitate cleaning out the housing unit.

102. An animal housing unit as claimed in claim 101, wherein said tie-down hinges are at both the front and the rear of the housing unit.

103. Two or more animal housing units each comprising a closed top hutch and an open top pen at a front of the hutch, the hutch supporting a slideable roof that can be slid between an extended position over the pen and a retracted position in which the sliding roof does not extend as far over the pen, and a bar that is attached to at least two roofs of said housing units so as to slide said roofs together.

104. An animal housing unit as claimed in claim 103, further comprising a second said bar, with one of said bars attached at a front and the other bar attached at a rear of said roofs.

105. A bedding tray for an animal housing unit, the bedding tray being sized and shaped to lie atop a floor of the unit and receive bedding material placed on the tray, the tray being partially or fully movable relative to the floor of the unit after the bedding material has been soiled so as to remove used bedding materials from the housing unit.

106. A bedding tray as in claim 105, wherein the tray is rollable from one end so as to remove bedding material on top of the bedding tray by rolling one end of the tray above and toward the opposite end of the tray.

107. An animal housing unit as claimed in claim 105, wherein one end of the bedding tray is attached to the floor of the unit and the other end of the tray is rollable toward the attached end.

108. An animal housing unit as claimed in claim 107, wherein sides of the bedding tray have sidewalls that are separated by openings to create living hinges so the tray can be rolled.

109. A floor structure for an animal housing unit, wherein the floor comprises one or more plastic tile grates defining a grid of open area.

110. A floor structure as claimed in claim 109, wherein the total open area of each tile grate is in the range of 44-52% of the total area of the tile grate.

111. A floor structure as claimed in claim 109, wherein the floor tiles are thermoformed.

112. A floor structure as claimed in claim 109, wherein each floor tile has recesses in an upper surface thereof.

113. A floor structure as claimed in claim 109, wherein each floor tile has projections in an upper surface thereof.

114. A floor structure as claimed in claim 113, wherein the projections are of a height within the range of 0.015-0.25 inches.

115. A floor structure as claimed in claim 109, wherein each floor tile has an elastomeric top layer.
